(19) United States
(12) Patent Application Publication
(10) Pub. No.: US 2002/0187557 A1
(43) Pub. Date: Dec. 12, 2002

(54) Systems and methods for introducing samples into microfluidic devices

(76) Inventors: Steven E. Hobbs, West Hills, CA (US); Christoph D. Karp, Pasadena, CA (US)

Correspondence Address: NANOSTREAM, INC., 580 SIERRA MADRE VILLA AVE., PASADENA, CA, 91107-2928, US

(21) Appl. No.: 10/161,415

(22) Filed: Jun. 3, 2002

Related U.S. Application Data
(60) Provisional application No. 60/296,897, filed on Jun. 7, 2001.
(60) Provisional application No. 60/357,683, filed on Feb. 13, 2002.

(51) Int. Cl. G01N 30/02

(52) U.S. Cl. 436/161; 436/175; 436/178; 436/180; 422/69; 422/70; 422/81; 422/100; 422/101; 210/656; 210/198.2

(57) ABSTRACT

A pressure-driven microfluidic device for separating chemical or biological species from a sample includes on-column injection, namely, a separation channel containing stationary phase material and a sample input disposed between a first end and a second end of the separation channel or column. One or many separation channels may be provided in a single microfluidic device, which may be fabricated with sandwiched stencil layers using various materials including polymers. Sealing means associated with a sample input, such as a mechanical seal adapted to selectively seal the sample input, are provide. Various sample injector configurations are provided. A separation system including a microfluidic device having on-column injection further includes a pressure source and a detector.

### STATEMENT OF RELATED APPLICATION(S)

This application claims benefit of U.S. patent application Ser. No. 60/296,897, filed Jun. 7, 2001 and currently pending, and U.S. patent application Ser. No. 60/357,683, filed Feb. 13, 2002 and currently pending, both of which are incorporated by reference as if set forth fully herein.

### FIELD OF THE INVENTION

The present invention relates to the introduction of fluid samples into microfluidic devices.

### BACKGROUND OF THE INVENTION

Chemical and biological separations are routinely performed in various industrial and academic settings to determine the presence and/or quantity of individual species in complex sample mixtures. There exist various techniques for performing such separations.

One separation technique, chromatography, encompasses a number of methods that are used for separating closely related components of mixtures. In fact, chromatography has many applications including separation, identification, purification, and quantification of compounds within various mixtures. Chromatography is a physical method of separation involving a sample (or sample extract) being dissolved in a mobile phase (which may be a gas, a liquid or a supercritical fluid). While carrying the sample, the mobile phase is then forced (e.g., by gravity, by applying pressure, or by applying an electric field) through a separation ‘column’ containing an immobile, immiscible stationary phase. In column chromatography, the stationary phase refers to a coating on a solid support that is typically contained within a tube or other boundary. The mobile phase and stationary phase are chosen such that components of the sample have differing solubilities in each phase. A component that is quite soluble in the stationary phase will take longer to travel through it than a component that is not very soluble in the stationary phase but very soluble in the mobile phase. As a result of these differences in mobilities, sample components become separated from one another as they travel through the stationary phase.

One category of conventional chromatography systems includes pressure-driven systems. These systems are operated by supplying a pressurized mobile phase (typically one or more liquid solvents pressurized with a pump) to a separation column. Standard liquid chromatography columns have dimensions of several (e.g., 10, 15, 25) centimeters in length and between 3-5 millimeters in diameter, with capillary columns typically having internal diameters between 3-200 microns. Columns are typically packed with very small diameter (e.g., 5 or 10 micron) particles. Various types of stationary phase material types are commercially available. Some of the more common examples include Liquid-Liquid, Liquid-Solid (Adsorption), Size Exclusion, Normal Phase, Reverse Phase, Ion Exchange, and Affinity.

It is important to minimize any voids in a packed column, since voids or other irregularities in a separation system can destroy an otherwise good separation. As a result, most conventional separation columns include specially designed end fittings (typically having compressible ferrule regions) designed to hold packing material in place and prevent irregular flow-through regions.

As illustrated in FIG. 1, a separation column for use in a conventional pressure-driven chromatography system is typically fabricated by packing particulate material 14 into a tubular column body 12. A conventional column body 12 has a high precision internal bore 13 and is manufactured typically with stainless steel, although materials such as glass, fused silica, and/or PEEK are also occasionally used. Various methods for packing a column body may be employed. In one example, a simple packing method involves dry-packing an empty tube by shaking particles downward with the aid of vibration from a sonicator bath or an engraving tool. A cut-back pipette tip may be used as a particulate reservoir at the top (second end), and the tube to be packed is plugged with parafilm or a tube cap at the bottom (first end). Following dry packing, the plug is removed and the tube 10 is then secured at the first end with a ferrule 16A, a fine porous stainless steel fritted filter disc (or “frit”) 18, a male end fitting 20A, and a female nut 22A that engages the end fitting 20A. Corresponding connectors (namely, a ferrule 16B, a male end fitting 20B, and a female nut 22B) except for the frit 18 are engaged to the second end to secure the dry-packed tube 12. The contents 14 of the tube 12 may be further compressed by flowing pressurized solvent through the packing material 14 from the second end toward the first (frit-containing) end. When compacting of the particle bed has ceased and the fluid pressure has stabilized, there typically remains some portion of the tube 13 that does not contain densely packed particulate material. To eliminate the presence of a void in the column 10, the tube 13 is typically cut down to the bed surface (or a shorter desired length) to ensure that the resulting length of the entire tube 12 contains packed particulate 14, and the unpacked tube section is discarded. Thereafter, the column 10 is reassembled (i.e., with the ferrule 16B, male end fitting 20B, and female nut 22B affixed to the second end) before use.

A conventional pressure-driven liquid chromatography system utilizing a column 10 is illustrated in FIG. 2. The system 30 includes a solvent reservoir 32, a high pressure pump 34, a pulse damper 36, a sample injection valve 38, and a sample source 40 all located upstream of the column 10, and further includes a detector 42 and a waste reservoir 44 located downstream of the column 10. The high pressure pump 34 pumps mobile phase solvent from the reservoir 32. A pulse damper 36 serves to reduce pressure pulses caused by the pump 34. The sample injection valve 38 is typically a rotary valve having an internal sample loop for injecting a predetermined volume of sample from the sample source 40 into the solvent stream. Downstream of the sample injection valve 38, the column 10 contains stationary phase material that aids in separating species of the sample. Downstream of the column 10 is a detector 42 for detecting the separated species, and a waste reservoir 44 for ultimately collecting the mobile phase and sample products. A back pressure regulator (not shown) may be disposed between the column 10 and the detector 42.

The system 30 generally permits one sample to be separated at a time in the column 10. Due to their cost, columns are often re-used for several separations (e.g., typically about 100 times). Following one separation, the column 10 may be flushed with a pressurized solvent stream in an attempt to remove any sample components still contained in the stationary phase material 14. However, this time-consuming flushing or cleaning step rarely yields a completely clean column 10. This means that, after the first separation performed on a particular column, every subsequent separation may potentially include false results due to contaminants left behind on the column from a previous run. Eventually, columns become fouled to the point that they are no longer useful, at which point they are generally discarded.

From the foregoing description, it is clear that conventional pressure-driven separation columns include numerous components and require numerous manufacturing steps. It would be desirable to reduce the number of parts required to fabricate separation columns, and to simplify their manufacture. It would also be desirable to reduce the cost of a separation column to permit the column to be disposed after a single use, thus eliminating potentially false results and time-consuming cleaning steps. It would be further desirable to provide high-throughput separation systems capable of separating multiple samples using a minimum number of expensive system components (e.g., pumps, pulse dampers, detectors, etc.).

Another separation technique utilizes an electric field applied across a column. These systems utilize a separation technique called electrophoresis, which is based on the mobility of ions in an electric field. Upon application of an electric field across a column containing an electrophoretic medium, components of the sample migrate at different rates toward the oppositely charged ends of the column based on their relative electrophoretic mobilities in the medium. Electrochromatography is a combination of chromatography and electrophoresis, in which the mobile phase is transported through the separation system by electroosmotic flow.

Separation systems relying on electric fields are complicated and require integral electrical contacts. Additionally, these systems only function with charged fluids or fluids containing electrolytes. Finally, these systems require voltages that are sufficiently high to cause electrolysis of water, thus forming bubbles that complicate the collection of samples without destroying them. In light of these limitations, there exists a need for devices and systems capable of providing separation utility without utilizing electrical currents.

### SUMMARY OF THE INVENTION

In a first separate aspect of the invention, a pressure-driven microfluidic separation device includes a separation channel containing stationary phase material, the separation channel having a first end and a second end. The separation device further includes a sample input adapted to provide a fluidic sample to the separation channel between the first end and the second end.

In another separate aspect of the invention, a pressure-driven microfluidic separation device includes multiple separation channels each having a first end and a second end. The separation device further includes multiple sample inputs, each input being in fluid communication with a separation channel and disposed between the first end and the second end.

In another separate aspect of the invention, a separation system includes a pressure-driven microfluidic separation device for separating a sample into multiple species, a pressure source adapted to supply a pressurized fluid to the separation device, and a detector adapted to detect a property of at least one species. The separation device has a separation channel and a sample input. The separation channel has a first end and a second end. The sample input is adapted to supply fluid to the separation channel. The sample input is disposed between the first end and the second end.

In another separate aspect of the invention, a method for loading a sample into a pressure-driven separation channel is executed in several steps. A first step includes providing a separation channel containing a stationary phase material. The separation channel has a first end, a second end, and a sample inlet port disposed between the first end and the second end. A second step includes initiating a flow of mobile phase solvent through the separation channel. A third step includes pausing the flow of mobile phase solvent. A fourth step includes supplying a sample to the sample inlet port. A fifth step includes sealing the sample inlet port.

In another separate aspect of the invention, any of the foregoing aspects may be combined for additional advantage. These and other aspects and advantages of the invention will be apparent to the skilled artisan upon review of the following detailed description, drawings, and claims.

### BRIEF DESCRIPTION OF THE DRAWINGS

FIG. 1 is a cross-sectional view of a conventional packed chromatography column.

FIG. 2 is a schematic showing various components of a conventional liquid chromatography system employing the packed chromatography column of FIG. 1.

FIG. 3 is an exploded perspective view of a pressure-driven microfluidic separation device having a single separation channel and a sample input adapted to inject sample onto the separation channel.

FIG. 4A provides two superimposed single solute study chromatograms for the separation of red dye and the separation of blue dye using the separation device of FIG. 3.

FIG. 4B is a combined study chromatogram for the separation of a mixture of red dye and blue dye using the separation device of FIG. 3.

FIG. 5A is an exploded perspective view of a pressure-driven microfluidic separation device having three separation channels and a sample input adapted to inject sample onto the three separation channels.

FIG. 5B is a top view of the assembled device of FIG. 5A.

FIG. 6 is a schematic view of a separation system including the pressure-driven microfluidic separation device of FIGS. 5A-5B.

FIG. 7 is a simplified cross-sectional view of a microfluidic separation device adapted to permit on-column optical detection.

FIGS. 8A-8F are simplified cross-sectional views of a pressure-driven microfluidic separation device and various operational methods that may be used to split a sample plug between a column and a waste outlet.

FIG. 9A is an exploded perspective view of a pressure-driven microfluidic separation device having eight separation channels and eight separate sample inputs adapted to inject different samples each separation channel.

FIG. 9B is a top view of the assembled microfluidic separation device of FIG. 9A.

FIG. 9C is an enlarged top view of a portion of the microfluidic separation device of FIGS. 9A-9B focusing on the sample injection ports and associated channels.

FIG. 10A is a top view of a microfluidic device having eight distinct sample injectors, each of a different design.

FIG. 10B provides another top view of the microfluidic device of FIG. 10A omitting the frit materials to more clearly illustrate the different injectors.

FIG. 10C is an exploded perspective view of the microfluidic device of FIG. 10A.

FIG. 11A is a top view of a microfluidic device having four distinct sample injectors, each of a different design.

FIG. 11B provides another top view of the microfluidic device of FIG. 11A omitting the frit materials to more clearly illustrate the different injectors.

FIG. 11C is an exploded perspective view of the microfluidic device of FIG. 11A.

FIG. 12A is a bottom view of an upper plate useful for providing a mechanical seal against one or more external fluidic ports of a microfluidic separation device.

FIG. 12B is a top view of a lower plate adapted to mate with the upper plate of FIG. 12A.

FIG. 12C is a top view of a removable carrier adapted to mate with the upper plate of FIG. 12A.

FIG. 12D is a bottom view of the carrier of FIG. 12C.

FIG. 12E is an exploded view showing a cross-section of the carrier, a slide adapted to fit into a recess defined by the carrier, and two screws for manipulating the slide within the carrier.

FIG. 12F is a cross-sectional view showing the assembled components of FIG. 12E.

FIG. 12G shows a multi-column microfluidic separation device having on-column injection ports superimposed in bottom view against the upper plate of FIG. 12A.

FIG. 12H is an exploded cross-sectional view of the microfluidic separation device and upper plate of FIG. 12G, the lower plate of FIG. 12B, the components illustrated in FIG. 12F, and further screws useful for joining the upper plate and the lower plate.

FIG. 13 is a schematic showing various components of a separation system adapted to perform liquid chromatography with a microfluidic separation device having at least one microfluidic separation channel and at least one sample input adapted to inject sample between a first end and a second end of the separation channel.

FIG. 14 is a block diagram depicting steps of a method for loading a sample into a pressure-driven separation channel.

### DETAILED DESCRIPTION OF PREFERRED EMBODIMENTS OF THE INVENTION

Definitions

The terms “channel” or “chamber” as used herein is to be interpreted in a broad sense. Thus, such terms are is not intended to be restricted to elongated configurations where the transverse or longitudinal dimension greatly exceeds the diameter or cross-sectional dimension. Rather, such terms are meant to comprise cavities or tunnels of any desired shape or configuration through which liquids may be directed. Such a fluid cavity may, for example, comprise a flow-through cell where fluid is to be continually passed or, alternatively, a chamber for holding a specified, discrete amount of fluid for a specified amount of time. “Channels” and “chambers” may be filled or may contain internal structures comprising, for example, valves, filters, stationary phase media, and similar or equivalent components and materials.

The term “microfluidic” as used herein refers to structures or devices through which one or more fluids are capable of being passed or directed, and which have at least one dimension less than about 500 microns.

The term “separation channel” is used substantially interchangeably with the term “column” herein and refers to a region of a fluidic device containing stationary phase material adapted to separate species of a fluid sample

The term “substantially sealed” as used herein refers to a microstructure having a sufficiently low unintended leakage rate and/or volume under given flow, fluid identity, and pressure conditions. A substantially sealed device may include one or more inlet ports and/or outlet ports.

The term “self-adhesive tape” as used herein refers to a material layer or film having an integral adhesive coating on one or both sides.

The term “stencil” as used herein refers to a material layer or sheet that is preferably substantially planar through which one or more variously shaped and oriented portions have been cut or otherwise removed through the entire thickness of the layer, and that permits substantial fluid movement within the layer (e.g., in the form of channels or chambers, as opposed to simple through-holes for transmitting fluid through one layer to another layer). The outlines of the cut or otherwise removed portions form the lateral boundaries of microstructures that are formed when a stencil is sandwiched between other layers such as substrates or other stencils.

The term “column” as used herein refers to a region of a fluidic device containing stationary phase material, typically including packed particulate matter.

The term “slurry” as used herein refers to a mixture of particulate matter and a solvent, preferably a suspension of particles in a solvent.

Microfluidic Devices Generally

Devices according to the present invention are preferably microfluidic devices defining internal channels or other microstructures having at least one dimension smaller than about 500 microns. In an especially preferred embodiment, microfluidic devices according to the present invention are constructed using stencil layers or sheets to define channels and/or chambers. As noted previously, a stencil layer is preferably substantially planar and has a channel or chamber cut through the entire thickness of the layer to permit substantial fluid movement within the stencil layer. Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut portions through a material layer. While laser cutting may be used to yield precisely-dimensioned microstructures, the use of a laser to cut a stencil layer inherently involves the removal of some material. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permit robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers are intended to mate with one or more adjacent layers (such as stencil layers or substrate layers) to form a substantially enclosed device, typically having at least one inlet port and at least one outlet port.

A wide variety of materials may be used to fabricate microfluidic devices having sandwiched stencil layers, including-polymeric, metallic, and/or composite materials, to name a few. In certain embodiments, particularly preferable materials include those that are substantially optically transmissive to permit viewing and/or electromagnetic analyses of fluid contents within a microfluidic device. Various preferred embodiments may utilize porous materials, including filter materials, for device layers. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties.

Various means may be used to seal or bond layers of a device together, preferably to construct a substantially sealed structure. For example, adhesives may be used. In one embodiment, one or more layers of a device may be fabricated from single- or double-sided adhesive tape, although other methods of adhering stencil layers may be used. A portion of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thicknesses of these carrier materials and adhesives may be varied.

In another embodiment, device layers may be directly bonded without using adhesives to provide high bond strength (which is especially desirable for high-pressure applications) and eliminate potential compatibility problems between such adhesives and solvents and/or samples. Specific examples of methods for directly bonding layers of nonbiaxially-oriented polypropylene to form stencil-based microfluidic structures are disclosed in copending U.S. provisional patent application no. 60/338,286 (filed Dec. 6, 2001), which is hereby incorporated by reference. In one embodiment, multiple layers of 7.5-mil (188 micron) thickness “Clear Tear Seal” polypropylene (American Profol, Cedar Rapids, Iowa) including at least one stencil layer may be stacked together, placed between flat glass platens and compressed to apply a pressure of 0.26 psi (1.79 kPa) to the layered stack, and then heated in an industrial oven for a period of approximately 5 hours at a temperature of 154° C. to yield a permanently bonded microstructure well-suited for use with high-pressure column packing methods. One layer of metal (e.g., carbon steel) foil may be optionally inserted along the inside face of each glass platen to contact the outermost device layers using the same process to promote more even heating.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

Further embodiments may be fabricated from various materials using well-known techniques such as embossing, stamping, molding, and soft lithography.

In addition to the use of adhesives and the adhesiveless bonding method discussed above, other techniques may be used to attach one or more of the various layers of microfluidic devices useful with the present invention, as would be recognized by one of ordinary skill in attaching materials. For example, attachment techniques including thermal, chemical, or light-activated bonding steps; mechanical attachment (such as using clamps or screws to apply pressure to the layers); and/or other equivalent coupling methods may be used.

Pressure-driven Microfluidic Separation

Performing liquid chromatography in microfluidic volumes provides significant cost savings by reducing column packing materials, analytical and biological reagents, solvents, and waste. Microfluidic separation devices may also be made to be disposable, thus eliminating possible contamination of samples due to re-use of separation columns and eliminating the need to flush columns between separations. Embodiments fabricated with sandwiched stencil layers provide additional advantages, such as rapid and inexpensive prototyping and production, and the ability to use a wide range of materials portions of a device. Additionally, microfluidic devices are well-suited for performing multiple operations in parallel, thus permitting substantial increases in throughput (namely, the number of separations that can be performed within a particular period) to be obtained.

Embodiments of the present invention provide on-column, rather than precolumn, injection of samples onto one or more microfluidic separation columns. In other words, a preferred embodiment includes a microfluidic separation channel (or column) having a first end and a second end, wherein a sample is injected through a sample input (e.g., an input port, input channel, or other aperture) onto the channel between the first end and the second end. Providing on-column sample injection is distinct from pre-column injection used with conventional pressure-driven chromatography columns, since on-column injection prevents a sample from ever encountering potential irregularities and manufacturing imperfections (including dead volumes) that may be found at the upstream end of separation conventional columns.

Microfluidic Devices Employing On-column Injection

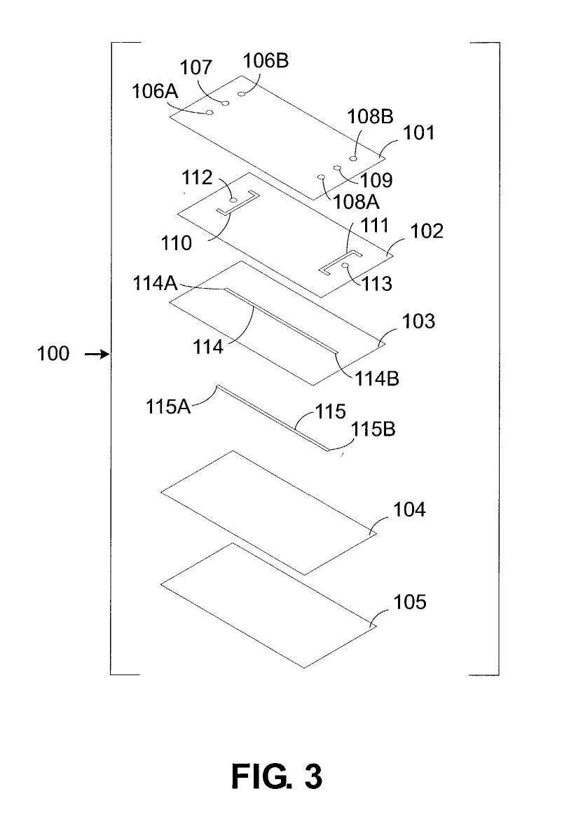

In one embodiment, a pressure-driven microfluidic separation device includes a separation column and an injection channel. Referring to FIG. 3, the separation device 100 is constructed with five device layers 101-105 including two stencil layers 102, 103. The first device layer 101 defines two upstream ports 106A, 106B, two downstream ports 108A, 108B, and two waste ports 107, 109. The second device layer 102, which is preferably constructed with a thermoplastic hot melt adhesive material, defines an injection channel 110, an unloading channel 111, and two vias 112, 113 for transmitting fluid between the first and third layers 101, 103. The third device layer 103 defines a straight channel 114 having an upstream end 114A and a downstream end 114B, the channel 114 being adapted to contain stationary phase material 115. The stationary phase material 115 has a corresponding upstream end 115A and a downstream end 115B. The fourth device layer 104 is preferably constructed with a thermoplastic (“hot melt”) adhesive material, and the fifth device layer 105 is preferably constructed with a rigid substrate. Various types of stationary phase material 115 may be used. In one embodiment, the stationary phase material 115 was fabricated using a strip of a commercially available silica gel thin layer chromatography (TLC) plate material into the device 100, the strip 115 being cut to the approximately dimensions of the channel 114 defined in the third layer 103. Following insertion of the strip 115 into the straight channel 114 and stacking of the device layers 101-104, the layers 101-104 were heat-laminated to cause portions of the second and fourth layers 102, 104 to close any gaps around the stationary phase strip 115. Other selectively flowable materials and adhesives other than thermoplastic materials may be used to accomplish the same purpose.

Following construction, the sample injection channel 110 provides very little impedance to fluid flow compared to the separation channel 114, since the microporous stationary phase material 115 contained in the separation channel 114 impedes fluid flow, both into and through the separation channel 114. Thus, a sample is preferably forced onto the stationary phase material 114 in order to form a small, well-defined injection plug. Further, injection of the sample is advantageously performed on the column 114 (i.e., between the upstream end 114A and the downstream end 114B) to prevent irregularities and manufacturing imperfections such as dead volumes in the stationary phase material 115 at the upstream end 114A from broadening the injected sample plug.

To prepare the device 100 for operation, solvent is initially provided to the injection channel 110 to pre-wet the stationary phase material 115 until solvent reaches the unloading channel 111. A mechanical seal (not shown), preferably removable, may be applied to one upstream port 106A or 106B (and/or the waste port 107) to permit the injection channel to be pressurized. After the column 115 is wetted, a sample is loaded via the injection channel 110 into the separation channel 114 and onto the stationary phase material 115 by applying pressure to force sample on the stationary phase material 114. Notably, the injection channel 110 crosses the separation channel 114 on an adjacent layer and well downstream of the upstream end 115A of the stationary phase material 115. The injection channel 110 is positioned a sufficient distance downstream of the upstream end 114A of the separation channel 114 to avoid distortion or broadening of the injection plug. After the sample is injected on the stationary phase material 115, one end of the injection channel is opened (e.g., by removing the mechanical seal) and excess sample is purged from the injection channel 110 with mobile phase solvent. After the mechanical seal is reapplied, pressurized mobile phase solvent may then be supplied to the column to elute the analytes. The analytes are separated as they flow through the stationary phase material 114.

An appropriate reverse process can be used to unload separated analytes from the separation channel 114. Again, imperfections at the downstream end 115B of the stationary phase material 115 are avoided with an unloading channel 111 (having a fluidic impedance much lower than the stationary phase material 115) that crosses the separation channel 114 on an adjacent layer upstream of the downstream end 115B of the stationary phase material 115. One end of the unloading channel 111 may be sealed, such as with a removable mechanical seal (not shown) to direct the fluid exiting the separation channel 115 toward a particular outlet port (e.g., 108A or 108B). Alternatively, a pressure differential may be applied across the outlet ports 108A, 108B to direct the unloaded fluid toward a particular port 108A or 108B. The waste ports 112, 113 may or may not be used, depending on the type of mechanical seal(s) used with the device 100 and the desired operating mode.

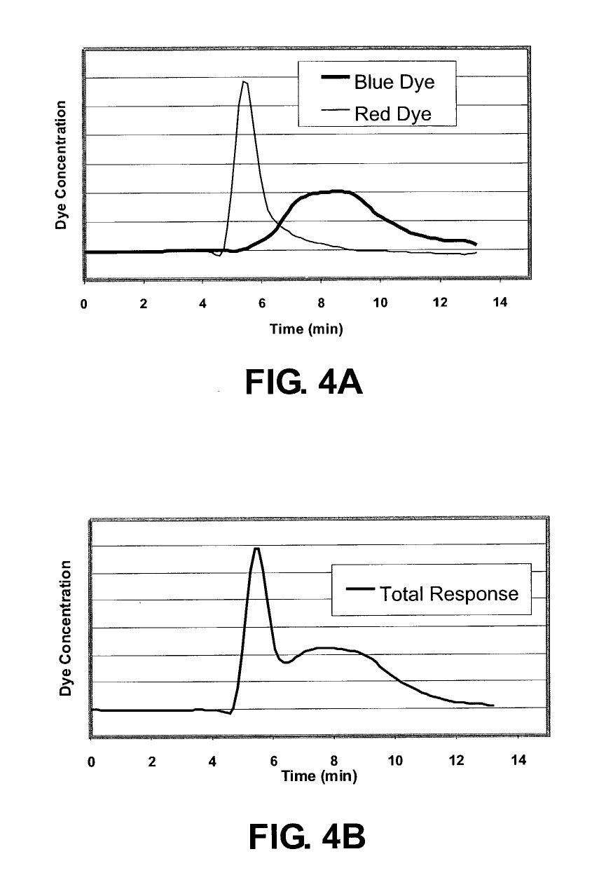

Preferably, one or more device layers 101-105 are constructed with substantially optically transmissive materials to promote optical detection of at least one fluid within the device 100. In one embodiment, optical detection of at least one fluid may be performed while the fluid remains in a separation and in contact with stationary phase material. A demonstration of on-column detection of two dyes was performed using a device 100 constructed according to the design of FIG. 3. A red dye (acid red) and blue dye (fast green) were separated on the stationary phase material 115 and detected by visible absorbance spectrometry. Light was transmitted through the separation channel 114, which contained a strip of commercially available silica gel thin layer chromatography (TLC) material 115. The mobile phase was a 9:1 mixture of water and ethanol. Separation was successfully achieved, with results of the demonstration provided in FIGS. 4A-4B. FIG. 4A provides two superimposed single solute study chromatograms (each study using one dye), while FIG. 4B is a combined study chromatogram showing separation of a mixture of the red dye and the blue dye.

In further embodiments, multiple separations may be performed simultaneously in a single fluidic device. The inherently small dimensions of microfluidic channels permit multiple channels to be integrated in a single device, which integration would be extremely difficult using conventional separation columns.

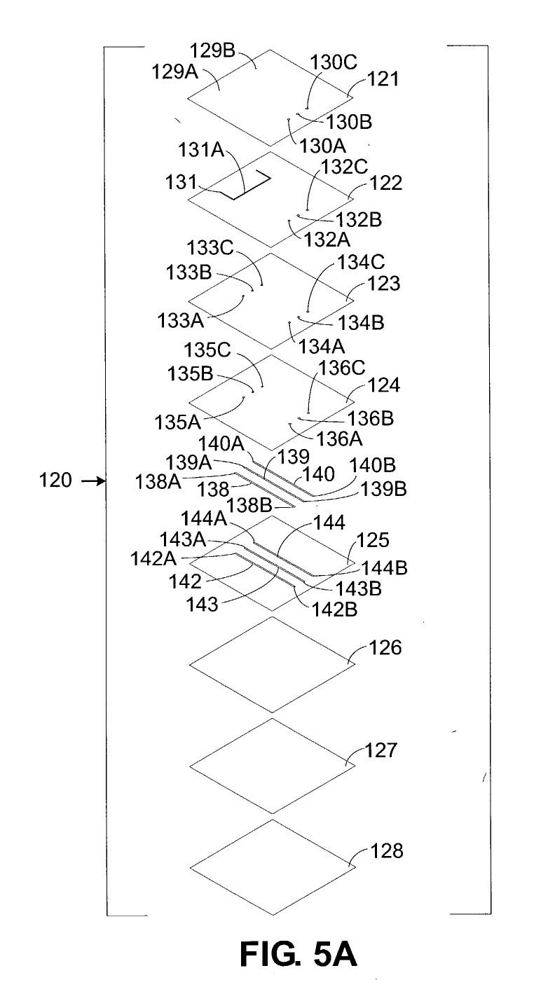

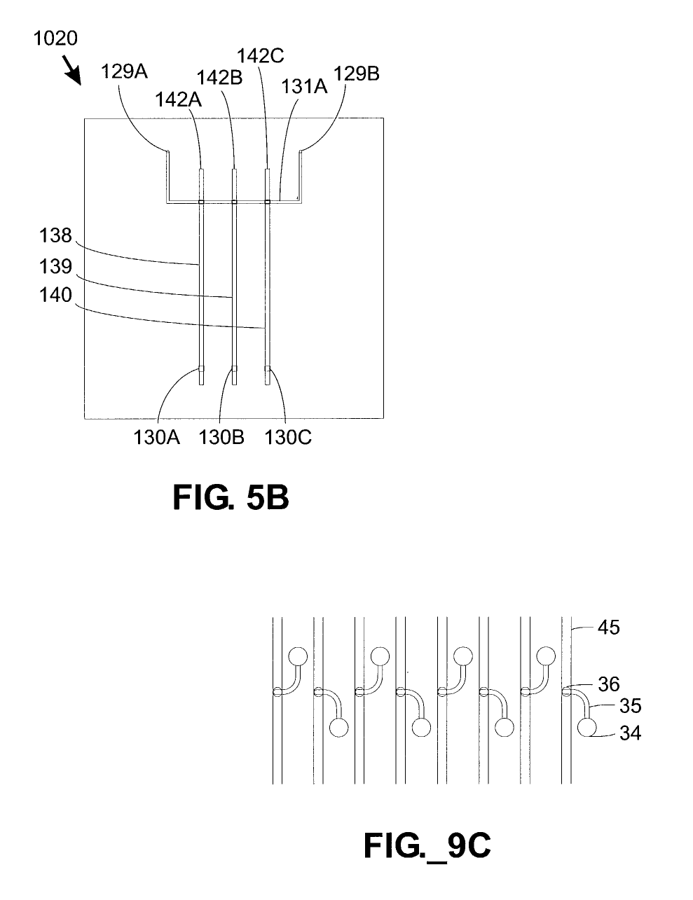

In one embodiment, multiple separation channels may be loaded from a single injection channel. After sample is provided to the injection channel, the injection channel may be pressurized to inject sample simultaneously into each of several separation channels. For example, referring to FIGS. 5A-5B, a multi-column microfluidic liquid chromatography (LC) device 120 was fabricated in eight layers 121-128, including stencil layers 122, 125, using a sandwiched stencil construction method. A laser cutter was used to cut and define various apertures and channels in the first five layers 121-125 of the device 120. The first (cover) layer 121, made of 10-mil (250 microns) thickness polyester film, included column inlet (injection) ports 129A, 129B and column outlet ports 130A-130C. The second layer 122 was made with a 5.8 mil (147 microns) thickness double-sided tape having a polyester carrier and rubber adhesive to adhere to the first and third layers 121, 123. The second (stencil) layer 122 defined an injection channel 131 having a segment 131A disposed perpendicular to the separation channels 142-144 defined in the fifth layer 125. The second layer 122 further defined vias 132A-132C aligned with the outlet ports 130A-130C. The third layer 123 and the fourth layer 124 defined vias in the same configuration: injection vias 133A-133C, 135A-135C and outlet vias 134A-134C, 136A-136C, respectively. The second layer 122 was constructed with a 0.8 mil (20 microns) thickness polyester film, and the third, fourth, sixth, and seventh layers 123, 124, 126, 127 were each constructed with 4-mil (102 microns) thickness modified polyolefin thermoplastic adhesive. Alternatively, a thicker thermoplastic adhesive layer, if available, could be substituted for the third and fourth layers 123, 124 (and likewise for the sixth and seventh layers 126, 127) to provide enough thermoplastic material to seal any gaps around the stationary phase material 138-140 in the separation channels 142-144. The fifth layer 125 was fabricated with a 10-mil (250 microns) thickness polyester film from which several separation channels 137, each 40 mils (1 mm) wide, were removed through the entire thickness of the fifth layer 125. The stationary phase material 138-140 was fabricated with 40-mil (1 mm) width strips of polyester coated with silica gel, each approximately 17 mils thick including a 250 μm coating thickness (Whatman, Inc., Clifton, N.J., Catalog No. 4410 221). Each strip 138-140 was placed into one of the three separation channels 142-144. The eighth layer 128 was a rigid substrate. Gaps around the stationary phase material strips 138-140 were sealed to prevent leakage by laminating the thermoplastic layers (the fourth, sixth, and seventh layers 123, 124, 126, 127) around the fifth layer 125 using a conventional pouch laminating machine. Following assembly of the device layers 121-127, the device 120 was re-laminated to ensure that any spaces around the stationary phase strips 138-140 were filled. Notably, while only three separation channels 142-144 are illustrated as present in the device 120, other embodiments according to similar designs may be easily constructed with a multitude of columns, without any loss of performance.

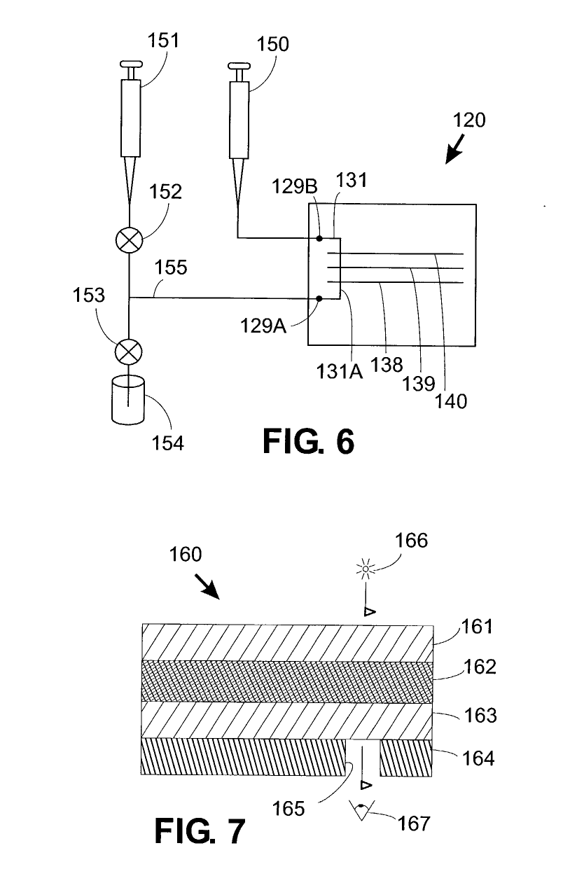

To operate the device 120, the inlet ports 129A, 129B were connected to two syringes 150, 151, valves 152, 153, and a waste reservoir 154 via flexible tubing 155 as shown in FIG. 6. The first syringe 150 contained water and the second syringe 151 contained an aqueous solution of acid red (red) and fast green (blue) dyes. The syringes 150, 151 were configured to be pressurized by applying weights (not shown) to the syringe plungers. The first valve 152 was initially closed and the second valve 153 was initially open. The stationary phase material 138-140 was first wetted with water by increasing the water pressure to 5 psi (34.5 kPa). The states of the two valves 152, 153 were then reversed, to cause the first valve 152 to open and the second valve 153 to close. The injection channel 131 was filled with dye solution by pressurizing the second syringe 151. The dye solution was not allowed to flow into the first syringe 1040. A pressure of 5 psi (34.5 kPa) was applied to both syringes 150, 151 to force dye into the three separation channels 142-144 containing stationary phase material 138-142, respectively. The states of the two valves 152, 153 were reversed again and water was flushed through the injection channel 131 to a waste container 154. The second valve 153 was then closed, and the first syringe 150 (containing water) was pressurized to approximately 5 psi (34.5 kPa) to propel the dye plugs through the columns 138-140. After the dye-plugs were separated in the three columns (i.e., separation channels 142-144 containing the stationary phase material 138-140), the water in the first syringe 150 was replaced with ethanol. The second valve 153 was opened and the injection channel 131 was then flushed with ethanol by pressurizing the first syringe 150. The second valve 153 was then closed and the first syringe 150 was pressurized to approximately 5 psi (34.5 kPa) to deliver ethanol until both dyes had eluted from the columns 142-144.

Generally, removal of a narrow fluid plug of analyte from a chromatography column is susceptible to broadening and consequent ruining of the separation. Thus, it is advantageous to be able to detect separated analytes on a column before the analytes encounter plug-broadening components. Microfluidic separation (e.g., liquid chromatography) devices described herein are highly amenable to on-column optical detection. For example, as shown schematically in FIG. 7, a microfluidic device 160 can be constructed of low-absorbance (i.e. substantially optically transmissive) materials so that light (whether within visible, ultraviolet, infrared, or any another spectrum of interest) can pass relatively unimpeded through the layers 161, 163 and column 162. Examples of preferred substantially optically transmissive materials include, but are not limited to: polypropylenes, polycarbonates, and glasses. Holes or other openings, such as aperture 165, can be defined in one or more substantially optically transmissive supporting layers (e.g., layer 164) adjacent to the substantially optically transmissive device layers 161, 163 that enclose the separation column 162, such as to permit flow-through analysis of species separated by a separation column. Alternatively, a hole (not shown) may be defined in a layer (e.g., layer 161) enclosing the column 162 and covered with a window of appropriate optical properties. Using a light source 166, light can be transmitted through one or more windows, or reflected back through a window after interacting with an analyte on the column 162. A detector 167, preferably disposed outside (or alternatively disposed within) the device 160, may be provided. These configurations enable a range of optical spectroscopies, including absorbance, fluorescence, Raman scattering, polarimetry, circular dichroism and refractive index detection. With the appropriate window material and optical geometry, techniques such as surface plasmon resonance and attenuated total reflectance can be performed. These techniques can also be performed off-column as well, or in a microfluidic device that does not employ a separation column. Window materials can also be used to permit other analytical techniques such as scintillation, chemilluminescence, electroluminescence, and electron capture. A range of electromagnetic energies can be used including ultraviolet, visible, near infrared and infrared. Additionally, techniques such as electrochemical detection, capacitive measurement, conductivity measurement, mass spectrometry, nuclear magnetic resonance, evaporative light scattering, ion mobility spectrometry, and matrix-assisted laser desorption ionization may be performed.

Analytical probes (not shown) can also be inserted into a microfluidic device, such as into a separation column. Examples of optical probes include absorbance, reflectance, attenuated total reflectance, fluorescence, Raman, and optical sensors. Other probes and sensors include wide ranges of electrochemical and biochemical probes.

In a preferred embodiment, electrodes are placed in the channels and/or chambers. As examples of various electrode configurations, wires may be placed between stencil layers so as to protrude into channels, wires may be propagated within channels, or stencil layers may be fabricated from conductive foils. Additionally, stencil layers may be patterned with metallic film. In further embodiments, current can be passed through conductive elements disposed in a microstructure to induce heating within the microstructure. Thermocouples can be constructed within the microstructure using the conductive elements to detect thermal changes. Calorimetry can be performed in this manner. In addition, a magnetic field can be induced in a similar manner. This magnetic field can be used to detect physical phenomena or induce flow using magnetic particles.

A number of materials can be used as stationary phase for liquid chromatography. Examples include, but are not limited to, powders of silica gel and silica gel coated with a chemical group such as an 18-carbon alkane. Functional powders have particle diameters typically ranging from 3 to 10 micrometers for high performance liquid chromatography, but can be hundreds of micrometers in diameter for low pressure liquid chromatographies. Using a slurry of particles contained in a liquid or a suspension of particles in a gas are typical methods of packing a column. Typically, a perforated (e.g., perforated stainless steel) filter material known as a packing frit must be painstakingly inserted into the downstream end before the packing and to the upstream end after the packing.

In one embodiment, a microfluidic separation device is amenable to a simplified packing method. According to this simplified packing method, particles are packed together before certain device layers of a multi-layer microfluidic device are laminated together. In one method, the particles are pressed into an open channel just prior to lamination of one or more adjacent layers. The particles can be applied as a dry powder or slightly wetted with a fluid. A conventional inert binder may be added to the fluid so that upon drying, the particles will be immobilized in the channel, thus avoiding the need for packing frits. If desired, a liner can be used to keep the particles away from the sealing surface of the layer. If used, the liner is preferably removed prior to lamination of the device. In another embodiment, particles are deposited with an inert binder onto a sheet, as is common in thin layer chromatography.

In open channel chromatography, stationary phase material is applied only to the inner walls of a capillary column by passing a dilute solution of the coating material through the capillary. This and similar methods can be applied to a microfluidic device after the device has been assembled. A simpler method entails coating a film of material with the stationary phase. The coated film can then be used as the upper and lower layers of a microfluidic assembly with the coated side of the film forming two edges of the column.

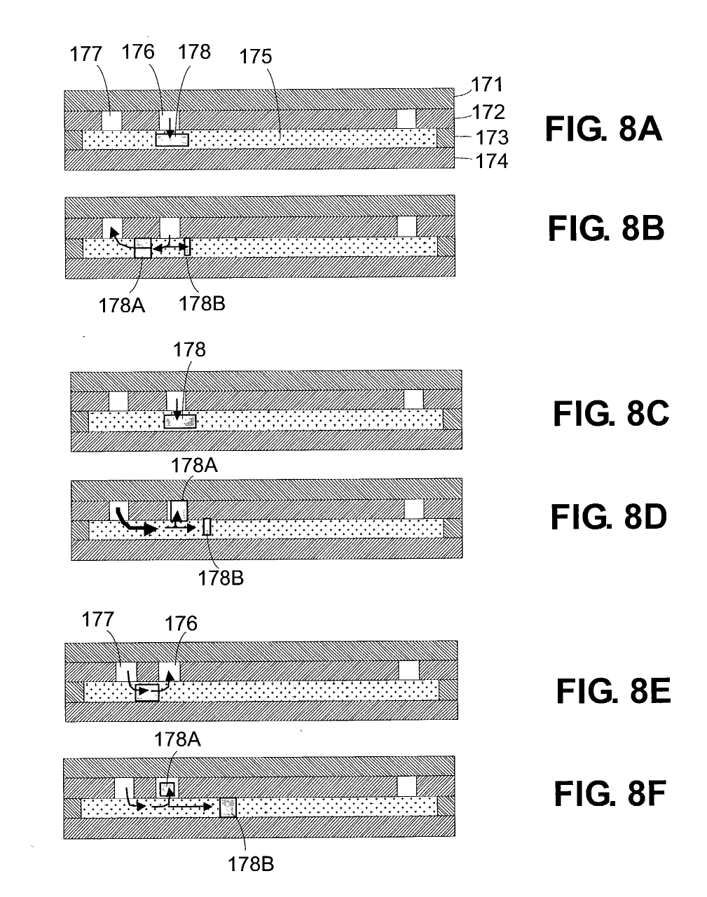

The quality of separation in chromatography depends heavily on the size of the injected sample plug, with a small and well-defined plug generally providing better results. The size of a sample plug within a microfluidic separation channel (column) according to the present invention may be varied by manipulating factors such as the stationary phase material, packing density, and changing the position at which the sample is loaded onto the column. In one embodiment, samples are injected in a cross-column configuration to aid in forming small injection plugs. The size of a sample injection plug can be further reduced after it is present on the separation column by directing part of the sample plug to a waste outlet. A microfluidic liquid chromatography device may be operated in different ways to split a sample plug on a separation columns. For example, FIGS. 8A-8F provide schematic cross-sectional views of at least a portion of a multi-layer microfluidic separation device 170 and various operational methods to split an injection plug 170 between a column 175 and a waste outlet 177. FIG. 8A illustrates the injection of a sample plug 178 from an injection channel 176. In FIG. 8B, a stream of solvent is provided to the column 175 by the injection channel 176. Since resistance to flow is greater along the length of the column than in the direction of the waste outlet 177, the majority of the solvent stream flows toward the waste outlet 177, carrying a large portion 178A of the injection plug. A small remaining portion 178B of the injection plug is carried by solvent and elutes down the column. After the plug 178 has been split, a valve or other sealing means (not shown) associated with or in the injection channel can be closed to prevent further flow into the waste channel 177. A second method of splitting an injected sample plug is illustrated in FIGS. 8C-8D. After a sample plug 178 is delivered to the column by the injection channel, solvent is provided to the column 175 through the waste channel 177. As solvent is added, a large portion 178A of the plug flows into the injection channel 176, and a smaller portion 178B remains in the column 175 to be separated. A third method of splitting an injected sample plug is illustrated in FIGS. 8E-8F. The spacing between the “waste” channel 177 and the “injection” channel 176 is reduced to provide a smaller ample plug. First, a sample plug 178 is delivered to the column 175 by the “waste” channel 177. As the “injection” channel 16 is maintained at a relatively low pressure, a large portion 178A of the plug flows into the “injection” channel 176 and a small portion 178B remains in the column 175. Solvent is provided to the column 175 through the “waste” channel 177, for carrying the small portion 178B to be eluted in the column 175.

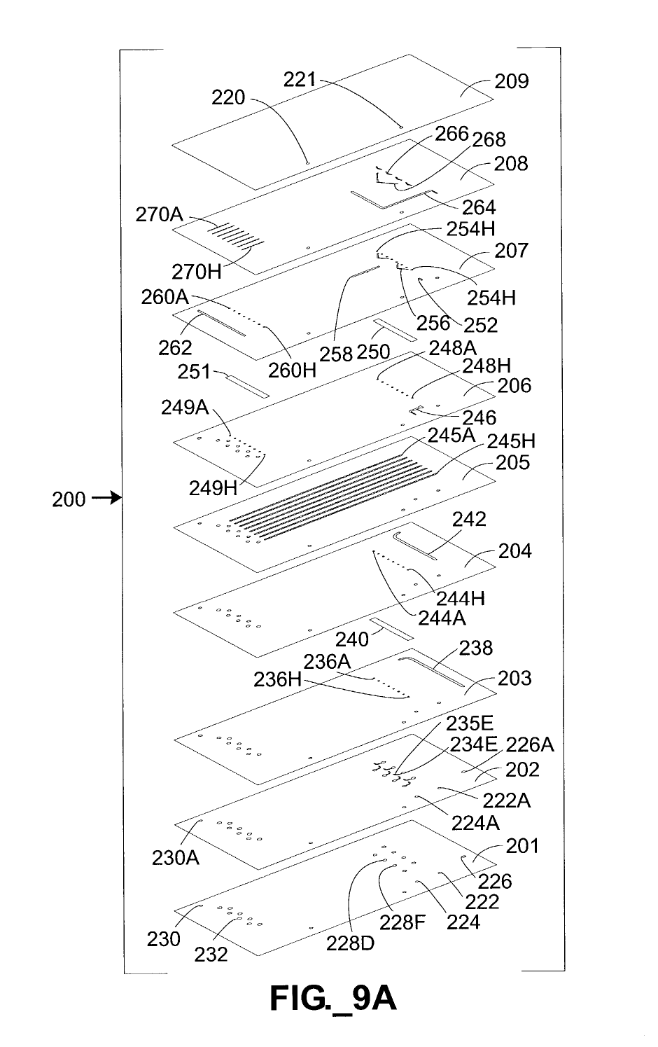

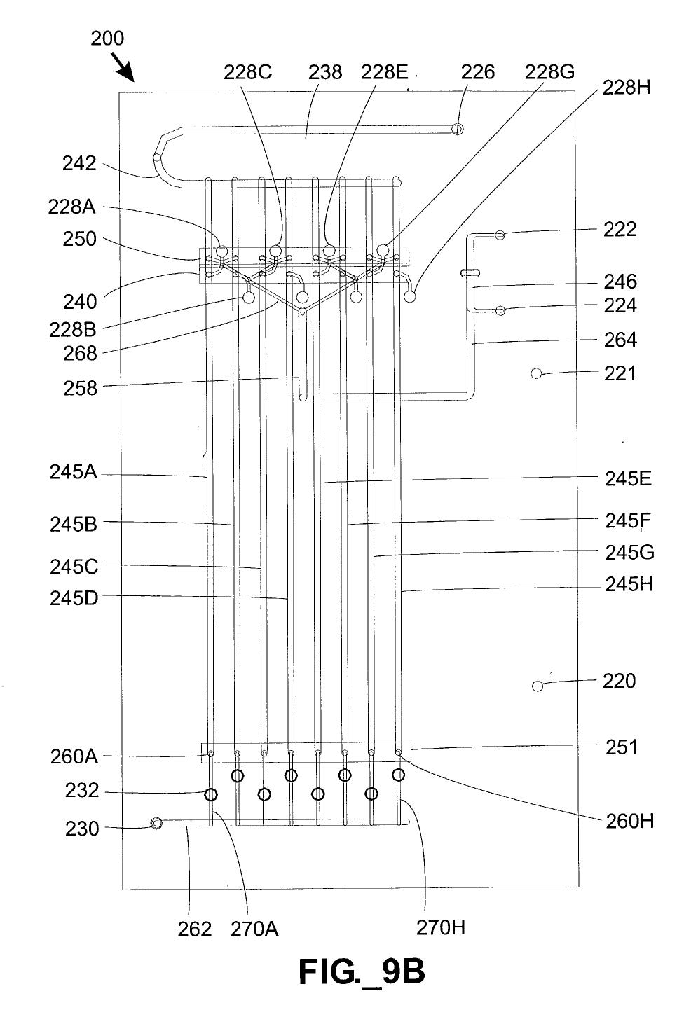

In a preferred embodiment, a microfluidic separation device includes multiple separation channels and multiple discrete sample inputs to permit multiple different samples to be separated simultaneously. Additionally, a preferred microfluidic device may be packed using a slurry of particulate material and solvent. For example, FIGS. 9A-9B illustrate a microfluidic separation device 200 constructed with nine layers 201-209, including multiple stencil layers 202-208. Each of the nine layers 201-209 defines two alignment holes 220, 221, which are used in conjunction with external pins (not shown) to aid in aligning the layers 201-209 during construction, and/or to aid in aligning the device 200 with an external interface (not shown) during a slurry packing process. The first layer 201 defines several fluidic ports: two solvent inlet ports 222, 224 that are used to admit (mobile phase) solvent to the device 200; eight sample ports 228A-228G that permit sample to be introduced to eight separation channels 245A-245G columns (each containing stationary phase material); a slurry inlet port 226 that is used during a column packing procedure to admit slurry to the device 200; and a fluidic port 230 that is used [1] during the packing process to exhaust (slurry) solvent from the device 200; and [2] during operation of the separation device 200 to exit mobile phase solvent and sample from the device 200 following separation. The first through sixth layers 201-206 each define eight optical detection windows 232. Defining these windows 232 through the first six layers 201-206 16 facilitates optical detection since it reduces the amount of material between an optical detector (not shown) such as a conventional UV-VIS spectrometer/detector, and the samples contained in channel segments 270 downstream of the separation channels 245A-245H.

The second through seventh layers 202-207 each define solvent vias 222A to transport a first mobile phase solvent to a solvent channel 264 defined in the eighth layer 208, with further solvent vias 224A defined in the second through fifth layers 202-205 to transport a second mobile phase solvent to a second solvent channel 246 defined in the sixth layer 206. Further vias 230A are defined in the second through sixth layers 202-206 to provide a fluid path between the fluidic port 230 and the channel 262 defined in the seventh layer 207. A via 226 defined in the second layer 202 communicates slurry from the slurry inlet port 226 to an elongate channel 238 defined in the third layer 203 during the slurry packing process. Preferably, particulate material deposited by the slurry packing process fills a first common channel 242 and at least a portion of a further upstream channel 238. The second layer 202 further defines eight sample channels 235A-235H, each having an enlarged region 234A-234H, respectively. Each enlarged region 234A-234H is aligned with one of the eight corresponding sample inlet ports 228A-228H defined in the first layer 201.

The third layer 203 defines an elongate channel 238 along with eight sample vias 236A-236H, which are aligned with the small ends of the sample channels 235A-235H. The fourth layer 204 defines eight sample vias 244A-244H aligned with the vias 236A-236H in the third layer 203. A porous material or (sample) frit 240, which functions to retain stationary phase material in the separation channels 245A-245H but permits the passage of sample, is placed between the third and fourth layers 203, 204 and spans across the sample vias 244A-244H in the fourth layer 204. Although various frit materials may be used, the frit 240 (along with frits 250, 251 within the device 200) is preferably constructed from a permeable polypropylene membrane such as, for example, 1-mil (25 microns) thickness Celgard 2500 membrane (55% porosity, 0.209×0.054 micron pore size, Celgard Inc., Charlotte, N.C.)—particularly if the layers 201-209 of the device 200 are bonded together using an adhesiveless thermal bonding method. Applicants have obtained favorable results using this specific frit material, without noticeable wicking or lateral flow within the frit despite using a single strip of the frit membrane to serve multiple adjacent separation channels 245A-245H containing stationary phase material. As a less-preferred alternative to the single porous frit 240, multiple discrete frits (not shown) may be substituted, and various porous material types and thicknesses may be used depending on the stationary phase material to be retained. The fourth layer 204 further defines a manifold channel 242 that provides fluid communication with the separation channels 245A-245H defined in the fifth layer 205 and the elongate channel 238 defined in the third layer 203. The separation channels 245A-245H are preferably about 40 mils (1 mm) wide or smaller.

The sixth layer 206 defines a solvent channel 246 that receives a second mobile phase solvent and transports the same to the slit 252 (defined in the seventh layer 207), which facilitates mixing of the two solvents in the channel 264 downstream of the slit 252. Further defined in the sixth layer 206 are a first set of eight vias 248A-248H (for admitting mixed mobile phase solvents to the upstream end of the separation channels 245A-245H and the stationary phase material contained therein), and a second set of eight vias 249A-249H at the downstream end of the same channels 245A-245H for receiving mobile phase solvent and sample. Two frits 250, 251 are inserted between the sixth and the seventh layers 206, 207. The first (mobile phase solvent) frit 250 is placed immediately above the first set of eight vias 248A-248H, while the second (mobile phase +sample) frit 251 is placed immediately above the second set of eight vias 249A-249H and below a similar set of eight vias 260A-260H defined in the seventh layer 207. The seventh layer 207 defines a channel segment 258, two medium forked channel segments 268, and eight vias 254A-245H for communicating mobile phase solvent through the frit 250 and the vias 248A-248H to the separation channels 245A-245H defined in the fifth layer 205 and containing stationary phase material. The seventh layer 207 further defines a transverse manifold channel 262—that receives mobile phase solvent and sample following separation, and that receives (slurry) solvent during column packing—for routing fluids through vias 230A to the fluidic exit port 230. The eighth layer 208 defines a mixing channel 264, one large forked channel segment 268, and four small forked channel segments 266. The eighth layer 208 further defines eight parallel channel segments 270A-270H downstream of the frit 251 for receiving (mobile phase) solvent and sample (during separation) or (slurry) solvent (during slurry packing), and for transporting such fluid(s) to the manifold channel 262 defined in the seventh layer 207. The ninth layer 209 serves as a cover for the channel structures defined in the eighth layer 208.

FIG. 9B is a top view of the assembled device 200 of FIG. 9A. FIG. 9C provides an expanded view of a portion of the device 200, focusing on the sample injection channels 235A-235H and associated separation channels 245A-245H. Each sample injection channel 235A-235H has an associated enlarged region 234 that is aligned with a sample inlet port 228A-228H defined in the first layer 201. For simplicity, the frit 240 has been omitted from FIG. 9C, although FIGS. 9A-9B correctly show the frit 240 placed between the sample vias 236A-236H, 244A-244H upstream of the point where samples are injected onto the separation channels 245A-245H to be filled with stationary phase column material.

Preferably, the various layers 201-209 of the device 200 are fabricated from unoriented polypropylene and bonded together using an adhesiveless thermal bonding method utilizing platens, as described above. This construction method yields a chemically-resistant device having high bond strength, both desirable attributes for withstanding a column packing process and subsequent operation to provide separation utility. Each separation channel 245A-245H is preferably adapted to operate a pressure greater than about 10 psi (69 kPa); is more preferably adapted to operate at a pressure greater than about 50 psi (345 kPa); and is even more preferably adapted to operate at a pressure greater than about 100 psi (690 kPa).

Particulate material deposited by a slurry packing process preferably fills the manifold or junction channel 242 and at least a portion of the channel 238. This leaves a “trailing edge” of packing (particulate stationary phase) material in the channel 238 that is far removed from the injection region (i.e., the mobile phase injection vias 244A-244H adjacent to frit 240 and the sample injection vias 248A-248H adjacent to the frit 250) where mobile phase and sample are provided to the separation channels 245A-245H. In operation, mobile phase solvent and sample are injected directly onto the stationary phase material in the separation channels 245A-245H, well downstream of the trailing edge of particulate material in the channel 238. It is beneficial to avoid sample flow through the trailing edge region of the particulate to promote high-quality separation, since the trailing edge is typically not well-packed. That is, since the quality of separation in chromatography depends heavily on the size of the injection plug, with a small and well-defined plug generally providing better results, it is desirable to avoid injecting a sample into a region that is not uniformly packed with particulate. On-column injection well downstream of the trailing edge of the packing material promotes small and well-defined sample plugs. Preferably, the channel 238 is permanently sealed (such as by collapsing the channel with focused thermal energy or by sealing with an epoxy) after packing of the particulate material is complete.

In liquid chromatography applications, it is often desirable to alter the makeup of the mobile phase during a particular separation to perform a process called gradient separation. If multiple separation columns are provided in a single integrated device (such as the device 200) and the makeup of the mobile phase is subject to change over time, then at a common linear distance from the mobile phase inlet it is desirable for mobile phase to have a substantially identical composition from one column to the next. This is achieved with the device 200 due to two factors: (1) volume of the path of each (split) mobile phase solvent substream is substantially the same to each column; and (2) each flow path downstream of the fluidic (mobile phase and sample) inlets is characterized by substantially the same impedance. The first factor, substantially equal substream flow paths, is promoted by design of the multi-splitter incorporating channel elements 258, 268, 256, and 266. The second factor, substantial equality of the impedance of each column (separation channel), is promoted by both design of the fluidic device 200 and the fabrication of multiple columns in fluid communication (e.g., having a common outlet) using a slurry packing method disclosed herein. Where multiple columns are in fluid communication with a common outlet, slurry flow within the device 200 is biased toward any low impedance region. The more slurry that flows to a particular region during the packing process, the more particulate is deposited to locally elevate the impedance, thus yielding a self-correcting method for producing substantially equal impedance from one separation channel 245A-245H to the next.

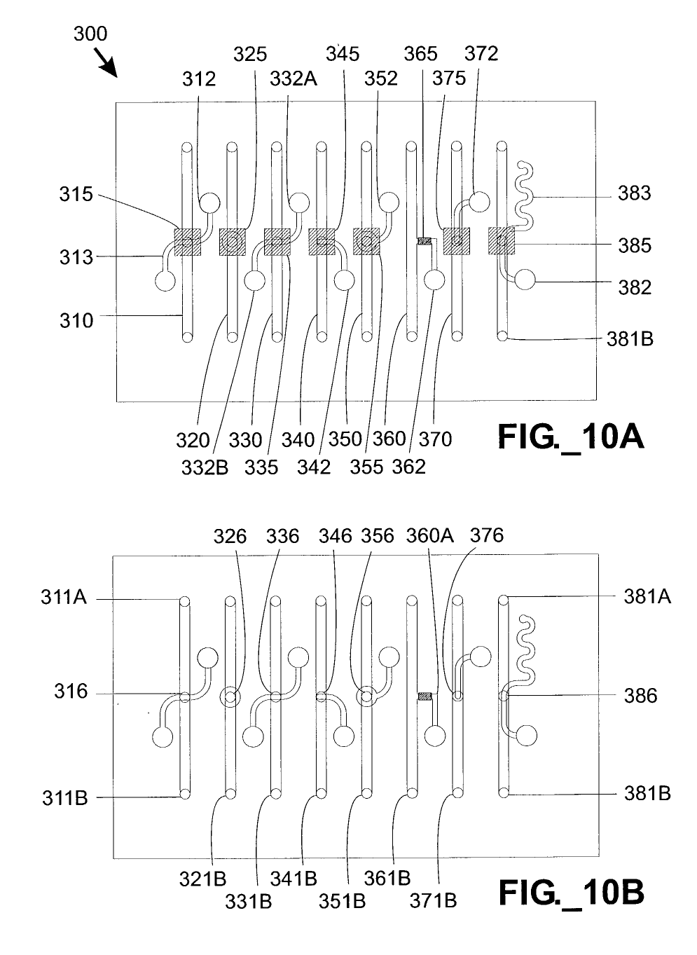

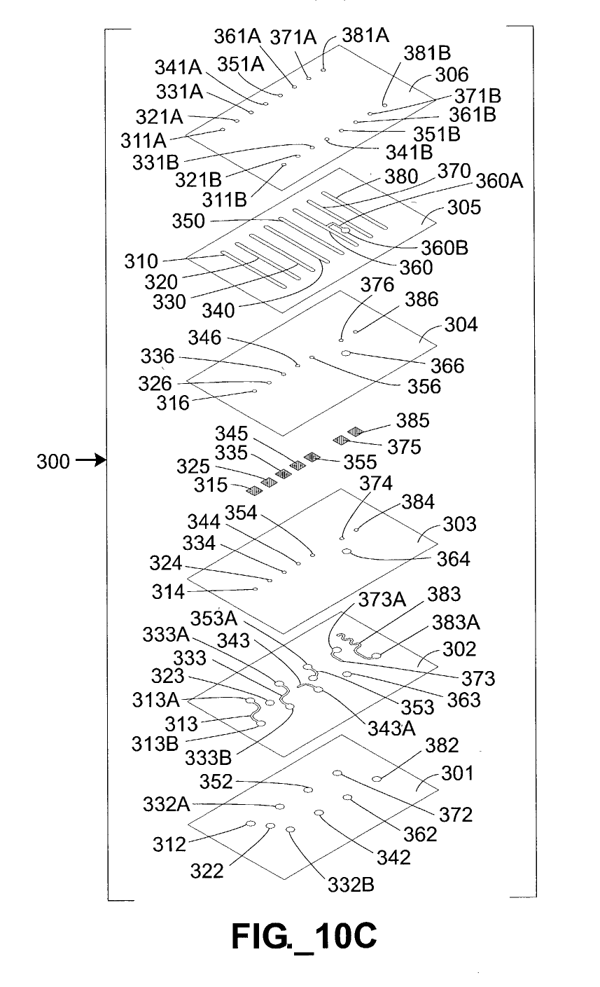

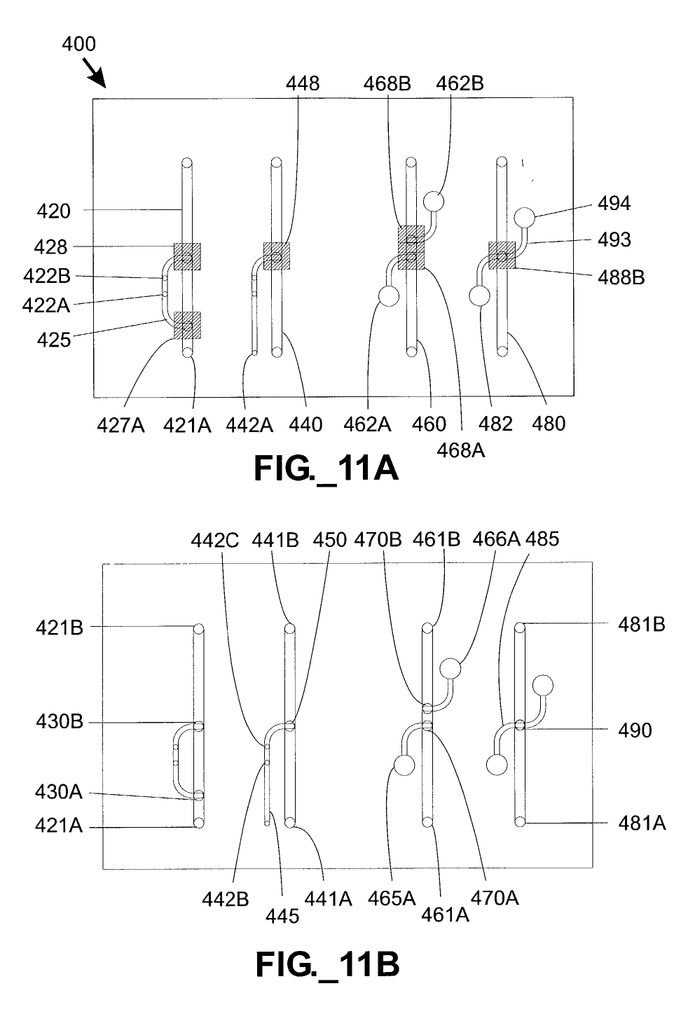

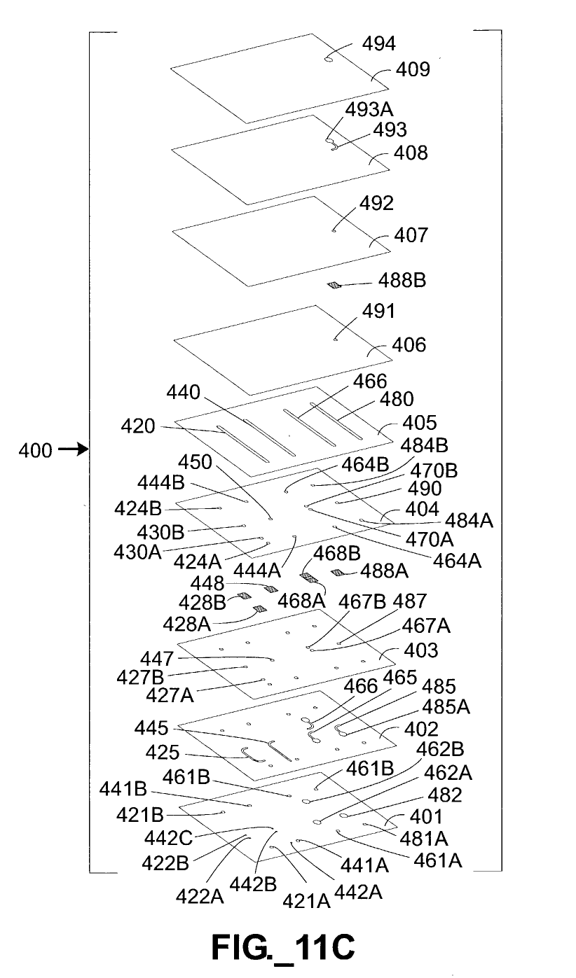

While the device 200 illustrated in FIGS. 9A-9C represents a preferred microfluidic separation device, a wide variety of other microfluidic separation devices may be similarly constructed. For example, the number and configuration of separation columns present in a single microfluidic device may be varied. To provide on-column injection utility, various alternative sample injector designs may be employed. Examples of twelve different injector designs are provided in FIGS. 10A-10C (illustrating eight different injector configurations) and FIGS. 11A-11C (illustrating four different injector configurations).

FIGS. 10A-10C illustrate a simplified microfluidic separation device 300 having eight separation channels 310, 320, 330, 340, 350, 360, 370, 380. The device 300 may be constructed with six device layers 301-306, including stencil layers 302, 305. The first layer 301 defines several sample ports 312, 322, 332A-332B, 342, 352, 362, 372, 382. The second layer 302 defines a first sample channel 313 having enlarged ends 313A, 313B, a second sample via 323, a third sample channel 333 having enlarged ends 333A-333B, a fourth sample channel 343 having an enlarged end 343A, a fifth sample channel 353 having enlarged ends 353A, 353B, a sixth sample via 363, a seventh sample channel 373 having an enlarged end 373A, and an eighth serpentine sample channel or overflow reservoir 383 having an enlarged end 383A. Alternatively, sample overflow reservoirs of various different sizes and shapes may be substituted for the reservoir 383. The third layer 303 defines multiple small vias 314, 324, 334, 344, 354, 374, 384 and one larger via 364. The fourth layer 304 is identical to the third layer 303, defining multiple small injection vias 316, 326, 336, 346, 356, 376, 386 and one larger via 386, with each via being in fluid communication with one of the eight separation channels 310, 320, 330, 340, 350, 360, 370, 380. Disposed between the third and fourth layers 303, 304 are multiple porous (preferably polymeric) frit elements 315, 325, 335, 345, 355, 375, 385 (e.g., 1-mil (25 microns) thickness Celgard 2500 membrane) and one larger via 385. The fifth layer 305 defines seven identical separation channels 310, 320, 330, 340, 350, 370, 380 and one distinct separation channel 360 having an injection segment 360A and an associated enlarged end 360B. Each separation channel 310, 320, 330, 340, 350, 360, 370, 380 is intended to contain stationary phase material (not shown). A frit element 365 (shown in FIGS. 10A-10B) is inserted into the injection segment 360A associated with the sixth separation channel 360. Each frit element 315, 325, 335, 345, 355, 365, 375, 385 is intended to permit the passage of sample while preventing stationary phase material from exiting the associated separation channel 310, 320, 330, 340, 350, 360, 370, 380. The sixth layer 306 defines sixteen fluid ports 311A, 311B, 321A, 321B, 331A, 331B, 341A, 341B, 351A, 351B, 361A, 361B, 371A, 371B, 381A, 381B, two ports each being associated with one separation channel 310, 320, 330, 340, 350, 360, 370, 380. The assembled device 300 is shown in top view in FIG. 10A. FIG. 10B provides a simplified top view of the device 300 omitting the frit elements 315, 325, 335, 345, 355, 375, 385.

If the assembled device 300 is oriented as shown in FIG. 10C, then mobile phase solvent is communicated to and from the device 300 from above through the sixteen fluid ports 311A, 311B, 321A, 321B, 331A, 331B, 341A, 341B, 351A, 351B, 361A, 361B, 371A, 371B, 381A, 381B, and samples are provided to the device 300 from below through the sample ports 312, 322, 332A-332B, 342, 352, 362, 372, 382. Preferably, however, the device 300 is oriented with the sample ports 312, 322, 332A-332B, 342, 352, 362, 372, 382 along the top to obtain the gravitational assistance in loading samples. The following operational description assumes the device 300 is oriented with the first layer 301 on top and the sixth layer 306 on the bottom.

To supply a first sample to the first separation channel 310, the first sample is injected into the first port 312. The first sample flows through one enlarged end 313A, a first via 314, a first frit 315, and another via 316 to contact the first separation channel 310. Excess sample not loaded onto the first separation channel 310 remains in the second layer 313 in a channel 313. Since the second enlarged end 313B of the channel 313 is closed, any air present in the channel 313 prior to sample loading will tend to compress into a bubble in the second enlarged end 313B.

To supply a second sample to the second separation channel 320, the second sample is injected into the second port 322 and flows through two vias 323, 324, through the second frit 325, and another via 326 before reaching the second separation column 320. One potential advantage of this second injector design is that it has a small footprint and small overall volume.

To supply a third sample to the third separation channel 330, the third sample is injected into a third port 332A. The third sample flows into channel 333, with a portion flowing through the associated via 334 centered on the channel 333, then through the frit element 335 and another via 336 into the third separation channel 330. Excess sample flows through the channel 333 to the outlet 332B defined in the first layer 301.

Design of the fourth injector is similar to that of the second injector, except with the addition of a channel 343 in the second layer 302. To supply a fourth sample to the fourth separation channel 340, the fourth sample is injected into the fourth port 342. The fourth sample then flows into the channel 343, then through a via 344, a frit 345, and another via 346 to reach the fourth separation channel 340.

Design of the fifth injector is similar to that of the fourth injector, except that the configuration of the channel 353 defined in the second layer 302 permits selective flow control using an external plunger (not shown) capable of contacting the first layer 301 adjacent to the enlarged end 353B of the channel 353. To supply a fifth sample to the fifth separation channel 350, the fifth sample is injected into the fifth port 352. The fifth sample then flows into the channel 353, then through a via 354, a frit element 355, and another via 356 to reach the fifth separation channel 350. Once the fifth sample is added to the device 300, the first layer 301 may be locally depressed using a plunger to permit a portion of the first layer 301 to extend through the second enlarged end 353B of the channel 353 and seal against the third layer 303 along the periphery of the via 354. Such operation can be useful, for example, to prevent excess sample contained in the channel 353 from leaching into the fifth separation channel 350.

The sixth injector is distinct from the previous designs in that it does not utilize a frit element disposed between device layers, but rather uses a frit 365 disposed within the injection channel 360A defined in the fifth device layer 305. To supply a fifth sample to the fifth separation channel 350, the fifth sample is injected into the fifth port 352. The fifth sample then flows into the channel 353, then through a via 354, a frit element 355, and another via 356 to reach the fifth separation channel 350.

The seventh injector is substantially similar to the fourth injector, except that the sample flow direction upstream of the seventh separation channel 370 is substantially parallel to the direction of the channel 370. To supply a seventh sample to the seventh separation channel 370, the seventh sample is injected into the seventh port 372. The seventh sample then flows into the channel 373, then through a via 374, a frit element 375, and another via 376 to reach the seventh separation channel 370.

The eighth injector provides a serpentine channel that directs excess sample away from the injection point 386 to reduce the likelihood that excess sample will leach into the separation channel 380. To supply an eighth sample to the eighth separation channel 380, the eighth sample is injected into the eighth port 382. The eighth sample then flows into the channel 383, then through a via 384, a frit element 385, and another via 386 to reach the eighth separation channel 380. Excess sample, if any, flows into the serpentine channel 383.

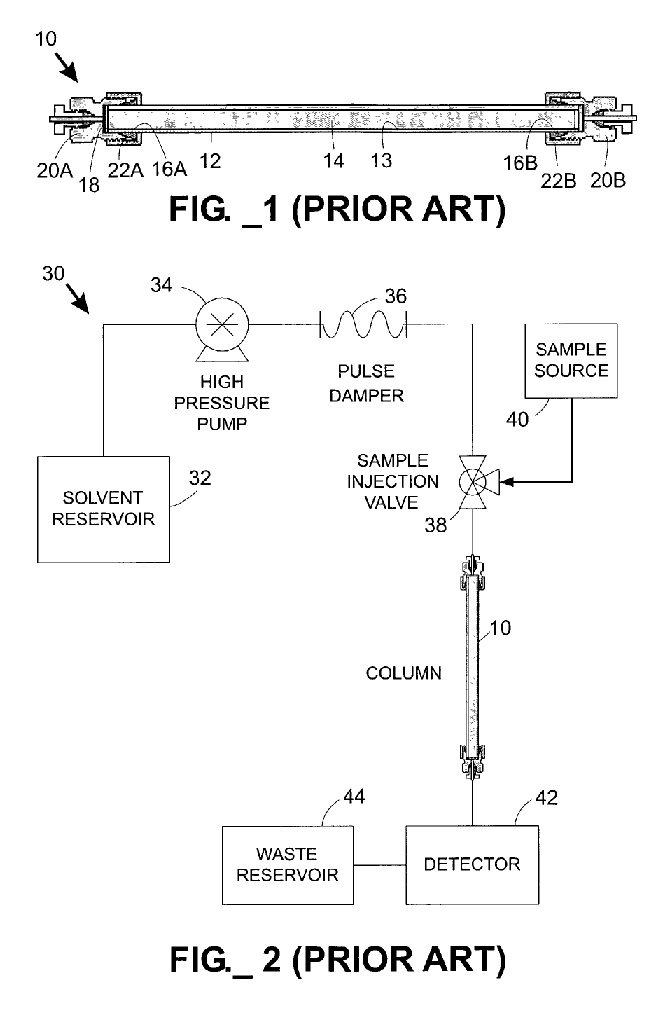

To provide four additional injector designs, FIGS. 11A-11C illustrate a simplified microfluidic separation device 400 having four separation channels 420, 440, 460, 480. The device 400 may be constructed with nine device layers 401-409, including three stencil layers 402, 405, 408. In contrast to the previous device 300 illustrated in FIGS. 1A-10C, most of the ports for sample and mobile phase solvent are provided along the same surface of the device 400. The first layer 401 defines several sample ports 422A, 422B, 442A, 442B, 442C, 462A, 462B, 482, along with eight peripheral ports 421A, 421B, 441A, 441B, 461A, 461B, 481A, 481B. The second through fourth layers 402-404 each define eight vias 424A, 424B, 444A, 444B, 464A, 464B, 484A, 484B aligned with the peripheral ports 421A, 421B, 441A, 441B, 461A, 461B, 481A, 481B in communication with the separation channels 420, 440, 460, 480 defined in the fifth layer 405. The second layer 402 further defines a first sample channel 425, a loading channel 445, third sample channel segments 465, 466, and a fourth sample channel 485 having an enlarged end 485A. The third and fourth layers 403, 404 define multiple sample vias 427A, 427B, 447, 467A, 467B, 487, 430A, 430B, 450, 470A, 470B, 490, with porous (preferably polymeric) frit elements 428A, 428B, 448, 468A, 468B, 488A being disposed between the third and fourth layers 403, 404 between corresponding sample vias 427A, 427B, 447, 467A, 467B, 487, 430A, 430B, 450, 470A, 470B, 490. The fifth layer 405 defines four separation channels 420, 440, 460, 480, and it is assumed that these channels are substantially filled with stationary phase material (not shown), such as packed particulate material. The sixth and seventh layers 406, 407 each define a via 491, 492 with a frit element 488A disposed between the layers 406, 407 along the vias 491, 492. The eighth layer 408 defines an excess sample channel 493 having an enlarged end 493A. Finally, the ninth layer 409 defines a single via 494 for carrying excess solvent from the device 400. The assembled device 400 is shown in top view in FIG. 11A. FIG. 11B provides a simplified top view of the device 400 omitting the frit elements 428A, 428B, 448, 468A, 468B, 488A, 488B.

Once the device 400 is assembled, mobile phase solvent may be supplied to the first, third, and fourth separation channels 420, 460, 480 by way of associated solvent ports 421A, 461A, 481A. In contrast to the other separation channels 420, 460, 480, mobile phase solvent is supplied to the third separation channel 440 by way of a smaller port 442A that is distinct from the third separation channel 440.

To supply a first sample to the first separation channel 420, the first sample is injected into one of the two small ports 422A, 422B disposed along the loading channel 425 that bypasses the separation channel 420. The two small ports 422A, 422B are selectively sealed, such as by using a removable mechanical seal (not shown) that may press against the first layer 401 adjacent to the ports 422A, 422B. To permit the first sample to be loaded, this mechanical seal is opened and mobile phase solvent flow is temporarily stopped. One advantage of this particular injector design is that it permits a small but repeatable volume of sample to be injected, since upon injection through one port 422A, 422B, the sample will flow into the loading channel 425 toward the other port 422A, 422B to define a sample plug in the portion of the loading channel 425 between the ports 422A, 422B. The volume of the loading channel 425 between the two ports 422A, 422B corresponds to the volume of the sample plug. After loading the sample plug, the mechanical seal is closed to disallow further flow through the ports 422A, 422B, and then solvent flow is re-established. Both frits 428A, 428B permit the passage of liquid (e.g., solvent and/or sample) but disallow stationary phase material (not shown) contained in the first separation channel 420 from migrating into the (bypass) loading channel 425. Mobile phase solvent flows in the direction from a first peripheral port 421A to a second peripheral port 421B. Because the loading channel 425 provides a fluid bypass to the first separation channel 420, a portion of the mobile phase solvent flows into the loading channel 425 and carries the sample plug into the first separation channel 420 to be eluted.

As noted previously, mobile phase solvent is supplied to the second separation channel through the smaller channel 445 by way of a port 442A. The smaller channel 445 has two more associated sample injection ports 442B, 442C that may be selectively sealed, such as by using a removable mechanical seal (not shown) that may press against the first layer 401 adjacent to the ports 442B, 442C. To permit the second sample to be loaded, this mechanical seal is opened and mobile phase solvent flow through the smaller channel 445 is temporarily stopped. To supply a second sample to the second separation channel 440, the second sample is injected into one of the two small ports 442B, 442C disposed along the smaller channel 425. As before, this design permits a small but repeatable volume of sample to be injected, since upon injection through one port 442B, 442C, the sample will flow into the smaller channel 445 toward the other port 442BA, 442C to define a sample plug in the smaller channel 445 between the ports 442B, 442C, with the volume of the portion of the smaller loading channel 445 between the two ports 442B, 442C corresponding to the volume of the sample plug. After loading the sample plug, the mechanical seal is closed to disallow further flow through the ports 442B, 442C, and then solvent flow is re-established in the channel 445. Mobile phase solvent flows toward the port 441 disposed at one end of the separation channel 440. The resumed flow of solvent in the smaller channel 445 carries the sample plug into the second separation channel 440 to elute species contained in the sample.

The design of the third injector (associated with the third separation channel 460) permits a sample plug to be defined within the separation channel 460. Sample may be provided to either of the two sample ports 462A, 462B, but it is assumed for sake of explanation that sample is provided to sample port 462A. Both sample ports 462A, 462B may be selectively sealed, such as by using a removable mechanical seal (not shown) that may press against the first layer 401 adjacent to the ports 462A, 462B. To permit the third sample to be loaded, this mechanical seal is opened and mobile phase solvent flow through the third separation channel 460 is temporarily stopped. To supply a third sample to the device 400, the third sample is injected into the first port 462A, from which is flows through one sample channel segment 465, two vias 467A, 470A, and a frit 468A into the separation channel 460. As before, this design permits a small but repeatable volume of sample to be injected, since upon injection through one port 462A, the sample will flow through the third separation channel 460 toward the other frit 468B and vias 470B, 467B to exit through another channel segment 466 and port 462B. The volume of the portion of the third separation channel 460 between the two apertures 4470A, 470B corresponds to the volume of the third sample plug. After loading the third sample plug, the mechanical seal is closed to disallow further flow through the ports 462A, 462B, and then solvent flow is re-established in the third separation channel 460. Mobile phase solvent flows from one port 461A to the other port 461B disposed at one end of the separation channel 440. The resumed flow of solvent in the third separation channel 460 carries the third sample plug along the third separation channel 460 to elute species contained in the third sample.

The fourth injector permits a sample plug to be loaded in a perpendicular direction across the fourth separation channel 480. Sample may be provided to either of the two sample ports 482, 494 disposed on opposite surfaces of the device 400, but it is assumed for sake of explanation that the fourth sample is provided to sample port 482. Both sample ports 482, 494 may be selectively sealed, such as by using removable mechanical seals (not shown) that may press against the first layer 401 adjacent to the sample port 482 defined therein, and against the ninth layer 409 adjacent to the sample port 494 defined therein. To permit the fourth sample to be loaded, both mechanical seals are opened and mobile phase solvent flow through the fourth separation channel 480 is temporarily stopped. To supply a fourth sample to the device 400, the fourth sample is injected into one sample port 482, from which it flows through a channel segment 485, a via 487, a frit 488A, and another via 490 into the fourth separation channel 480. The path of least resistance for the flowing fourth sample is perpendicularly through the fourth separation channel 480, through a via 491, another frit 488B another via 492, a channel 493, and to another sample port 494 to exit the device 400. As before, this design permits a small but repeatable volume of sample to be injected, since it results in formation of a fourth sample plug in the fourth separation channel 480, with the volume of the sample plug corresponding to the volume of the portion of the fourth separation channel 480 disposed between the adjacent sample vias 490, 491. After loading the fourth sample plug, the mechanical seals are closed to disallow further flow through the ports 482, 494, and then solvent flow is re-established in the fourth separation channel 480. Mobile phase solvent flows from one solvent port 481A to another port 481B disposed at one end of the fourth separation channel 480. The resumed flow of solvent in the fourth separation channel 480 carries the fourth sample plug along the fourth separation channel 480 to elute species contained in the sample.

Sealing the Sample Input(s)

As discussed previously, conventional pressure-driven chromatography systems operate with pre-column injection, such that samples are introduced into a solvent stream by a rotary valve upstream of a conventional separation column. Accordingly, a conventional pressure-driven separation column has only two fluidic connections: typically one fluidic input at the upstream end of the column and one fluidic output at the downstream end of the column. Separation devices according to the present invention, however, provide on-column sample injection, which gives rise to the need to selectively seal an on-column sample input. It is desirable to provide fluidic access to a separation channel to permit a sample introduction, and thereafter to seal the sample input to enable pressure-driven separation to be executed within the separation channel. While various means may be used to seal a sample input, preferably sealing is provided with a removable mechanical seal. Less preferred alternatives to mechanical sealing include localized thermal sealing and the use of adhesives.

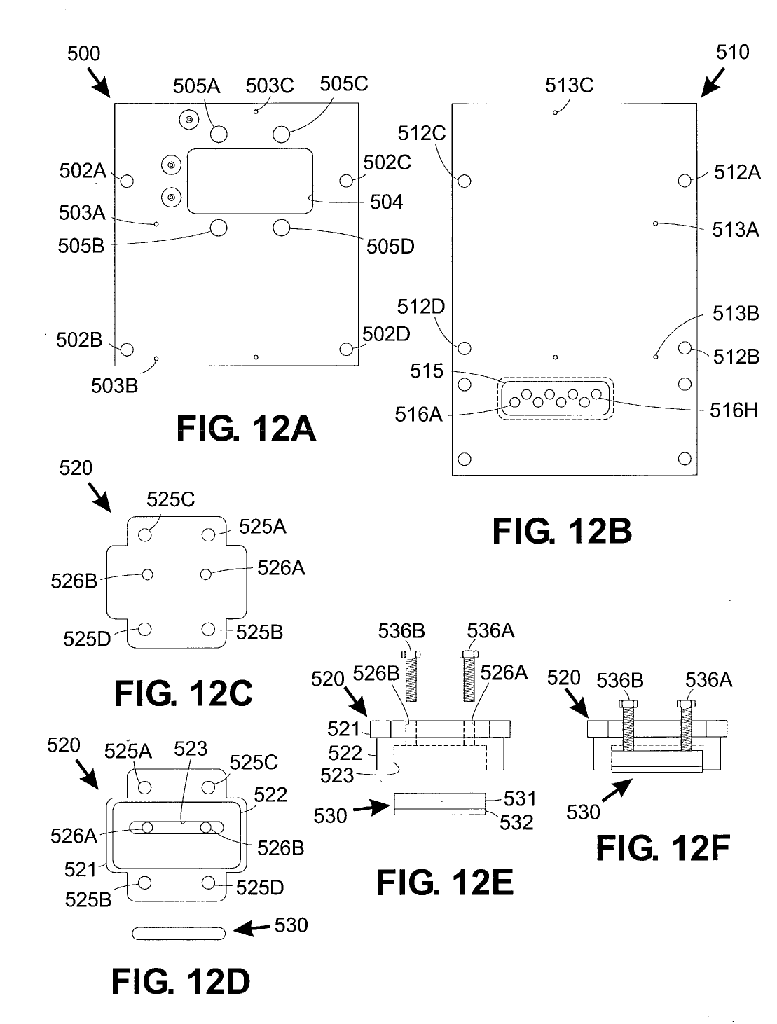

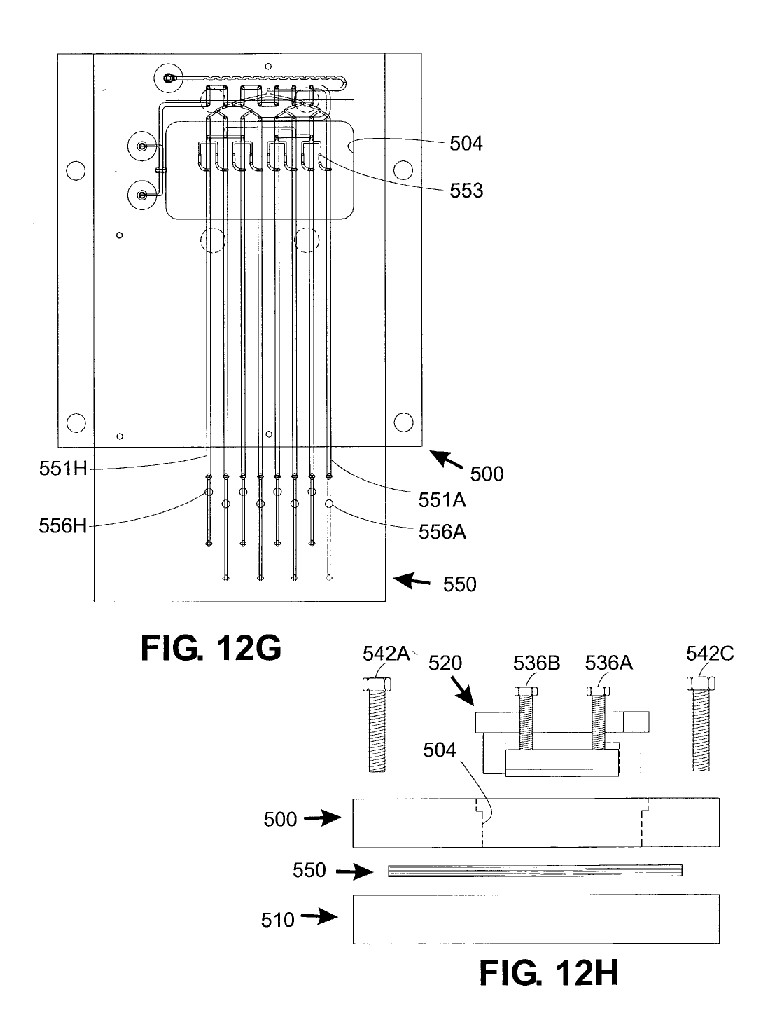

One example of a preferred mechanical sealing apparatus for use with a microfluidic separation device according to at least one embodiment of the present invention is provided in FIGS. 12A-12H. The sealing apparatus includes an upper plate 500, a lower plate 510, a carrier 520, and a slide 530. Preferably, both plates 500, 510 and the carrier 520 are fabricated with a substantially rigid material (such as aluminum) to prevent undesirable deflection. The carrier 530, however, preferably includes both a rigid portion 531 and an elastomeric portion 532 that serves as a gasket to seal against the upper surface of a microfluidic device along external sample ports. The elastomeric portion 532 is preferably formed with a relatively inert elastomeric material such as silicone rubber to minimize undesirable chemical interactions with solvents and/or samples.

A bottom view of the upper plate 500 is provided in FIG. 12A. The upper plate 500 defines a large aperture 504 adapted to fit at least a portion of the carrier 530. The upper plate 500 defines four peripheral apertures 502A-502D aligned with corresponding apertures 512A-512D defined in the bottom plate 510 (illustrated in FIG. 12B). The upper plate 500 further defines four carrier apertures 505A-505D that permit the carrier 520 to be fastened to the upper plate 500. Alignment apertures 503A-503C may be optionally provided in the upper plate to aid in aligning a microfluidic separation device (such as the device 550 illustrated in FIG. 12G) to the upper plate 500, such as by inserting alignment pins (not shown) into the alignment apertures 503A-503C, and then guiding a microfluidic device having corresponding apertures to the alignment pins.

A top view of a lower plate 510 adapted to mate with the upper plate 500 is illustrated in FIG. 12B. The lower plate 510 defines peripheral apertures 512A-512D aligned with the peripheral apertures 502A-502D defined in the upper plate 500. Preferably, the peripheral apertures 512A-512D defined in the lower plate 510 are tapped to permit screws (e.g., screws 542A, 542C illustrated in FIG. 12H) to be used to fasten the upper plate 500 to the lower plate 510 with a microfluidic separation device (e.g., device 550) sandwiched therebetween. Alignment apertures 513A-513C corresponding to the alignment apertures 503A-503C may be defined in the lower plate to aid in aligning the plates 500, 510 with a microfluidic device. The lower plate 510 may optionally include a detector region 515 having multiple detector apertures 516A-516H corresponding to one or more detection windows or detection regions in a microfluidic separation device. In one embodiment, fiber optic elements are fitted to the detector apertures 516A-516H to aid in providing detection capability.

Top, bottom, and cross-sectional views of a removable carrier 520 adapted to mate with the upper plate 510 are provided in FIGS. 12C, 12D, and 12E, respectively. The carrier 520 defines four upper plate mating apertures 525A-525D that correspond to the apertures 505A-505D defined in the upper plate 500. Preferably, the apertures 505A-505D defined in the upper plate 500 are tapped to permit screws (not shown) to be inserted through the upper plate mating apertures 525A-525D and engage the apertures 505A-505D to removably fasten the carrier 520 to the upper plate 500. A recess 523 is defined in the lower portion 522 of the carrier 520. The recess 520 is adapted to fit a slide 530. Additionally, the carrier 520 defines two central apertures 526A-526B, which are positioned above the recess 523 and are preferably tapped to accept adjusting screws 536A-536B that permit the position of the slide 530 to be adjusted. Preferably, only the lower portion 522 of the carrier 520 is adapted to fit into the large central aperture 504 defined in the upper plate 500, such that upon insertion the upper portion 521 of the carrier 500 may be restrained from downward movement by the upper surface of the upper plate 500. The slide 530 is adapted to fit substantially within the recess 523 defined in the carrier 520. An assembled view of the carrier 520 and the slide 530 is provided in FIG. 12F, showing that the slide 530 may be forced downward by rotating the adjusting screws 536A, 536B.

A multi-column microfluidic separation device 550 permitting on-column injection is illustrated in FIG. 12G superimposed in bottom view against the upper plate 500. The microfluidic device 500 is similar in design to the device 200 illustrated in FIGS. 9A-9B, but includes injectors according to the second injector design illustrated in FIGS. 11A-11C (i.e., the injector design including apertures 442A, 442B disposed along a loading channel 445). Notably, the device 550 includes eight parallel separation channels 551A-551H and eight detection regions 556A-556H adapted to mate with the eight detector apertures 516A-516H defined in the lower plate 510. Preferably, the detection regions 556A-556H are fabricated with substantially optically transmissive regions to aid detection of one or more properties of species. The device 550 includes multiple external sample injection ports 553 disposed along the separation channels 551A-551H. When the separation device 550 is aligned with the upper plate 500, the sample injection ports 553 are disposed below the recess 504 to permit the slide 530 to engage and seal the sample injection ports 553. An exploded cross-sectional view of the microfluidic separation device 550 disposed between the plates 500, 510 and beneath the carrier 520 is shown in FIG. 12H. The outer screws 542A, 542C permit the upper plate 500 to engage the lower plate 500 around the microfluidic device 550 by way of peripheral apertures 502A-502D, 512A-512D.

In operation, the upper and lower plates 500, 510 are assembled around the microfluidic device 550 as illustrated in FIG. 12H. The carrier 520 is inserted into the large aperture 504 defined in the upper plate 500, and the slide 530 is pressed downward by tightening the two adjusting bolts 536A, 536B to seal the sample injection ports 503. A mobile phase solvent is supplied to the separation channels 551A-551H to thoroughly wet stationary phase material contained within the separation channels 551A-551H. Next, flow of the mobile phase solvent is paused, which reduces the pressure within the separation channels 551A-551H. The adjusting bolts 536A, 536B are loosened to retract the slide 530 so as to unseal the sample injection ports 551A-551H, and the carrier 520 is removed from the upper plate 500 to provide easy access to the ports 551A-551H. One or more samples may be provided to the ports 551A-551H using a pipettor or another conventional fluid dispenser. Each separation channel 551A-551H receives a sample downstream of its upstream end (i.e., via on-column sample injection). After the samples are loaded, the carrier 520 and slide 530 are reinserted into the aperture 504 defined in the upper aperture 504, and the adjusting bolts 536A, 536B are tightened to seal the sample injection ports 551A-551H with the elastomeric portion 532 of the slide 530. Thereafter, flow of mobile phase may be reinitiated to separate each sample into its component species along the separation channels 551A-551H.

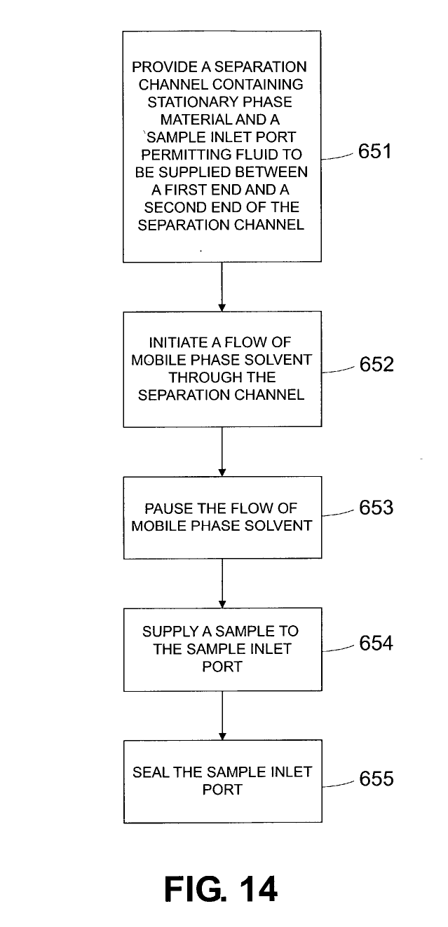

Several of the foregoing sample loading method steps are summarized in a flow chart in FIG. 14. A first step 651 includes providing a separation channel containing a stationary phase material and a sample inlet port permitting fluid to be supplied between a first end and a second end of the separation channel. A second step 652 includes initiating a flow of mobile phase solvent through the separation channel. A third step 653 includes pausing the flow of mobile phase solvent. A fourth step 654 includes supplying a sample to the sample inlet port. Finally, a fifth step 655 includes sealing the sample inlet port. These method steps may be executed using the components (e.g. upper plate 500, lower plate 510, carrier 520, and slide 530) and the microfluidic device 550 illustrated in FIGS. 12A-12H.

Separation System

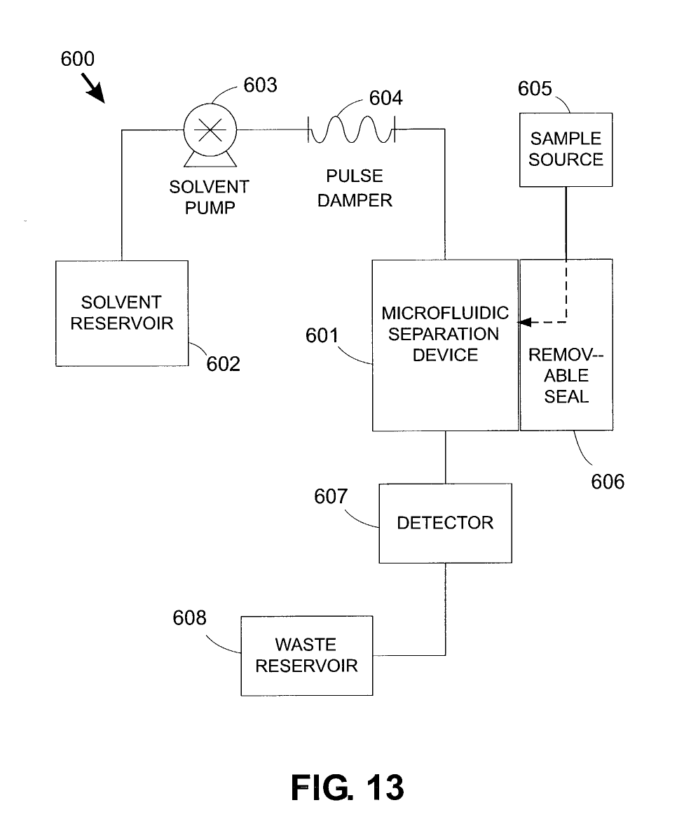

FIG. 13 provides a schematic showing various components of a separation system 600 adapted to separate species using a technique such as liquid chromatography with a microfluidic separation device 601 permitting on-column sample injection. A solvent reservoir 602 contains mobile phase solvent. While a single reservoir 602 is shown, multiple reservoirs 602 may be provided to perform gradient separation. A solvent pump 603 pressurizes mobile phase solvent supplied from the reservoir 602. If additional solvent reservoirs 602, then preferably additional pump(s) 603 are also provided. In an alternative embodiment, the pump(s) 603 may be replaced by a pressure source such as pressurized gas (e.g., nitrogen) supplied directly to the solvent reservoir(s) 602 to motivate a flow of mobile phase solvent through the microfluidic separation device 601. The microfluidic separation device 601 receives mobile phase solvent from the reservoir(s) 602 and also receives one or more samples that are injected onto one or more separation channels (columns) contained in the device 601. In other words, each separation channel has a first end and a second end, and each the sample is provided to a separation channel between the first end and the second end. A removable seal (e.g., a mechanical seal) is provided to selectively seal the sample input(s). A detector 607 is positioned downstream of the separation channels. The detector 607 may be joined with or separate from the microfluidic device 601. Various types of detection technology may be used, as detailed previously. Downstream of the detector 607 is a waste reservoir 608. In an alternative embodiment, a sample collector (not shown) may be substituted for the waste reservoir 608. Although not shown, the system 600 preferably further includes a controller for controlling the various components of the system 600.

It is to be understood that the illustrations and descriptions of views of individual microfluidic devices, components, and methods provided herein are intended to disclose components that may be combined in a working device. Various arrangements and combinations of individual devices, components, and methods provided herein are contemplated, depending on the requirements of the particular application. The particular microfluidic, components, and methods illustrated and described herein are provided by way of example only, and are not intended to limit the scope of the invention.

What is claimed is:

1. A pressure-driven microfluidic separation device comprising:
a separation channel having a first end and a second end, and containing stationary phase material; and
a sample input adapted to provide a fluidic sample to the separation channel between the first end and the second end.

2. The microfluidic separation device of claim 1 wherein the device is fabricated with a plurality of device layers, at least one device layer of the plurality of device layers is a stencil layer having a thickness, and the stencil layer defines at least one channel through the entire thickness of the stencil layer.

3. The microfluidic separation device of claim 1, wherein the device is fabricated with a plurality of device layers, and at least one device layer of the plurality of device layers is fabricated with a polymeric material.

4. The microfluidic separation device of claim 1, further comprising a mechanical seal adapted to selectively seal the sample input.

5. The microfluidic separation device of claim 1, further comprising means for selectively sealing the sample input.

6. The microfluidic separation device of claim 1 wherein the sample input is adapted to receive a fluidic sample from a pipettor.

7. The microfluidic separation device of claim 1 wherein the stationary phase material includes packed particulate material.

8. The microfluidic separation device of claim 7, further comprising a porous material adapted to retain the stationary phase material within the separation channel.

9. The microfluidic separation device of claim 8 wherein the porous material is polymeric.

10. The microfluidic separation device of claim 1 wherein the separation channel is adapted to operate at a pressure greater than or equal to about 10 psi.

11. The microfluidic separation device of claim 1 wherein the separation channel is adapted to operate at a pressure greater than or equal to about 50 psi.

12. The microfluidic separation device of claim 1 wherein the sample input includes a sample inlet port in fluid communication with the separation channel.

13. The microfluidic separation device of claim 12 wherein the sample input includes a sample outlet port in fluid communication with the sample inlet port.

14. The microfluidic separation device of claim 13, further comprising a sample flow path between the sample inlet port and the sample outlet port, wherein the sample flow path includes a portion of the separation channel.

15. The microfluidic separation device of claim 13, further comprising:
a bypass channel bypassing a portion of the separation channel; and
a sample flow path between the sample inlet port and the sample outlet port;
wherein the sample flow path includes at least a portion of the bypass channel.

16. The microfluidic separation device of claim 13, further comprising:
a loading channel in fluid communication with the separation channel; and
a sample flow path between the sample inlet port and the sample outlet port;
wherein the sample flow path includes at least a portion of the loading channel.

17. The microfluidic separation device of claim 12 wherein the sample input includes a sample overflow reservoir in fluid communication with the sample inlet port.

18. The microfluidic separation device of claim 17, further comprising a sample flow path between the sample inlet port and the sample overflow reservoir, wherein the sample flow path includes a portion of the separation channel.

19. A pressure-driven microfluidic separation device comprising:
a plurality of separation channels each having a first end and a second end; and
a plurality of sample inputs, each sample input of the plurality of sample inputs being in fluid communication with a separation channel of the plurality of separation channels and being disposed between the first end and the second end.

20. The microfluidic separation device of claim 19 wherein the device is fabricated with a plurality of device layers, and at least one device layer of the plurality of device layers is a stencil layer.

21. The microfluidic separation device of claim 19 wherein the device is fabricated with a plurality of device layers, and at least one device layer of the plurality of device layers is fabricated with a polymeric material.

22. The microfluidic separation device of claim 19, further comprising a mechanical seal adapted to selectively seal at least one sample input of the plurality of sample inputs.

23. The microfluidic separation device of claim 19, further comprising means for selectively sealing at least one sample input of the plurality of sample inputs.

24. The microfluidic separation device of claim 19 wherein the plurality of sample inputs are adapted to receive at least one sample from a pipettor.

25. The microfluidic separation device of claim 19 wherein the plurality of separation channels contain stationary phase material, and the stationary phase material includes packed particulate material.

26. The microfluidic separation device of claim 25, further comprising at least one porous material adapted to retain the stationary phase material within the plurality of separation channels.

27. The microfluidic separation device of claim 26 wherein the porous material is polymeric.

28. The microfluidic separation device of claim 19 wherein the plurality of separation channels is adapted to operate at a pressure greater than or equal to about 10 psi.

29. The microfluidic separation device of claim 19 wherein the plurality of separation channels is adapted to operate at a pressure greater than or equal to about 50 psi.

30. The microfluidic separation device of claim 19 wherein each sample input of the plurality of sample inputs includes a sample input port.

31. The microfluidic separation device of claim 19 wherein each sample input of the plurality of sample inputs includes a sample output port.

32. The microfluidic separation device of claim 31 wherein each sample input port is fluidically coupled to a sample output port via a sample flow path, and each sample flow path includes a portion of a separation channel of the plurality of separation channels.

33. The microfluidic separation device of claim 31, further comprising a plurality of bypass channels in fluid communication with the plurality of separation channels; wherein each sample input port and each sample output port are fluidically coupled to a bypass channel of the plurality of bypass channels via a sample flow path, and each sample flow path includes at least a portion of a bypass channel.

34. The microfluidic separation device of claim 31, further comprising a plurality of loading channels in fluid communication with the plurality of separation channels; wherein each sample input port and each sample output port are fluidically coupled to a loading channel of the plurality of loading channels via a sample flow path, and each sample flow path includes at least a portion of a loading channel.

35. The microfluidic separation device of claim 30 wherein each sample input of the plurality of sample inputs includes a sample overflow reservoir in fluid communication with a sample inlet port.

36. The microfluidic separation device of claim 35 wherein each sample input port is fluidically coupled to a sample overflow reservoir via a sample flow path, and each sample flow path includes at least a portion of a separation channel of the plurality of separation channels.

37. A separation system comprising:
a pressure-driven microfluidic separation device for separating a sample into a plurality of species, the separation device having a separation channel and a sample input, the separation channel having a first end and a second end, the sample input being adapted to supply fluid to the separation channel, and the sample input being disposed between the first end and the second end;
a pressure source adapted to supply a pressurized fluid to the separation device; and
a detector adapted to detect a property of at least one species of the plurality of species.

38. The separation system of claim 37, further comprising a removable mechanical seal capable of selectively sealing the sample input.

39. The separation system of claim 37 wherein the microfluidic separation device includes a detection region.

40. The separation system of claim 39 wherein the detection region includes a substantially optically transmissive region.

41. The separation system of claim 37 wherein the detector is a flow-through detector.

42. The separation system of claim 40 wherein the flow-through detector performs an analytical technique selected from the group consisting of: optical spectroscopy, chemilluminescence, electroluminescence; electrochemical detection, capacitive measurement, conductivity measurement, and electron capture.

43. The separation system of claim 37 wherein the detector performs an analytical technique selected from the group consisting of: mass spectrometry, nuclear magnetic resonance, evaporative light scattering, ion mobility spectrometry, scintillation, and matrix-assisted laser desorption ionization.

44. The separation system of claim 37 wherein the sample input is adapted to receive a sample from a pipettor.

45. The separation system of claim 37 wherein the pressure source includes a pump.

46. The separation system of claim 37 wherein the pressure source includes a reservoir of compressed fluid.

47. The separation system of claim 37 wherein the separation channel is adapted to operate at a pressure greater than or equal to about 10 psi.

48. The separation system of claim 37 wherein the separation channel is adapted to operate at a pressure greater than or equal to about 50 psi.

49. A method for loading a sample into a pressure-driven separation channel, the method comprising the steps of:
providing a separation channel containing a stationary phase material, the separation channel having a first end, a second end, and a sample inlet port permitting fluid communication with the separation channel between the first end and the second end;
initiating a flow of mobile phase solvent through the separation channel;
pausing the flow of mobile phase solvent;
supplying a sample to the sample inlet port; and
sealing the sample inlet port.
